(19) United States
(12) Patent Application Publication
(10) Pub. No.: US 2019/0317760 A1
(43) Pub. Date: Oct. 17, 2019

(54) Interactive And Dynamic Search Based Approach To Software Refactoring Recommendations

(71) Applicant: THE REGENTS OF THE UNIVERSITY OF MICHIGAN, Ann Arbor, MI (US)

(72) Inventors: Marouane KESSENTINI, Dearborn, MI (US); Vahid ALIZADEH, Dearborn, MI (US); Mohamed Wiem MKAOUER, Dearborn, MI (US)

(21) Appl. No.: 16/386,551

(22) Filed: Apr. 17, 2019

Related U.S. Application Data
(60) Provisional application No. 62/658,834, filed on Apr. 17, 2018.

(51) Int. Cl. G06F 8/72; G06F 8/65

(52) U.S. Cl. CPC G06F 8/72; G06F 8/65

(57) ABSTRACT

Refactoring improves he software design while preserving overall functionality and behavior, and is an important technique in managing the growing complexity of software systems. This disclosure introduces an interactive way to refactor software systems using innovization and interactive dynamic multi-objective optimization. The interactive approach supports the adaption of refactoring solutions based on developer feedback while also taking into account other code changes that the developer may have performed in parallel with the refactoring activity.

### CROSS-REFERENCE TO RELATED APPLICATIONS

This application claims the benefit of U.S. Provisional Application No. 62/658,834, filed on Apr. 17, 2018. The entire disclosure of the above application is incorporated herein by reference.

### FIELD

The present disclosure relates to an interactive and dynamic search-based approach to software refactoring recommendations.

### BACKGROUND

Successful software products evolve through a process of continual change. However, this process may weaken the design of the software and make it unnecessarily complex, leading to significantly reduced productivity, increased fault-proneness and cost of maintenance, and has even led to projects being canceled. Many studies report that software maintenance activities consume up to 90% of the total cost of a typical software project. It has also been shown that software developers typically spend around 60% of their time in understanding the code they are maintaining.

Clearly, software developers need better ways to manage and reduce the growing complexity of software systems and improve their productivity. The standard solution is refactoring, which involves improving the design structure of the software while preserving its functionality. There has been much work done on various techniques and tools for software refactoring and these approaches can be classified into three main categories: manual, semi-automated and fully-automated approaches, as outlined below. In manual refactoring, the developer refactors with no tool support at all, identifying the parts of the program that require attention and performing all aspects of the code transformation by hand. It may seem surprising that a developer would eschew the use of tools in this way, but researchers have found in their empirical study of the developers usage of the Eclipse refactoring tooling that in almost 90% of cases the developers performed refactorings manually and did not use any automated refactoring tools. In spite of its apparent popularity, manual refactoring is very limited however; several studies have shown that manual refactoring is error-prone, time-consuming, not scalable and not useful for radical refactoring that requires an extensive application of refactorings to correct unhealthy code.

By semi-automated refactoring, the situation is referred to where a developer uses the standard refactoring tooling available in IDEs, such as Eclipse and Netbeans, to apply the refactorings they deem appropriate. Researchers have analyzed data collected from 13,000 Java developers using the Eclipse IDE over a 9-month period, finding that the trivial Rename refactoring accounted for almost 72% of the refactorings performed, while the combination of Rename, Extract Method/Variable and Move accounted for 89.3% of the total number of refactorings performed.

In fully-automated refactoring, a search-based process is employed to find an entire refactoring sequence that improves the program in accordance with the employed fitness function (involving e.g., code smells, software quality metrics etc.). This approach is appealing in that it is a complete solution and requires little developer effort, but it suffers from several serious drawbacks as well. Firstly, the recommended refactoring sequence may change the program design radically and this is likely to cause the developer to struggle to understand the refactored program. Secondly, it lacks flexibility since the developer has to either accept or reject the entire refactoring solution. Thirdly, it fails to consider the developer perspective, as the developer has no opportunity to provide feedback on the refactoring solution as it is being created. Furthermore, as development must halt while the refactoring process executes, fully-automated refactoring methods are not useful for floss refactoring where the goal is to maintain good design quality while modifying existing functionality. The developers have to accept the entire refactoring solution even though they prefer, in general, step-wise approaches where the process is interactive and they have control of the refactorings being applied.

In light of the discussion above, this disclosure propose an approach to refactoring recommendation that (1) provides refactoring- centric interaction based on the preferences and feedback of developers, (2) enables refactoring and development to proceed in parallel and (3) collects information in a non-intrusive manner that can be used to inform dynamically the refactoring process in an intelligent manner to provide better recommendations. Enabling the developer to interact with the refactoring solution is essential both to creating a better refactoring solution, and to creating a solution that the developer understands and can work with.

This section provides background information related to the present disclosure which is not necessarily prior art.

### SUMMARY

This section provides a general summary of the disclosure, and is not a comprehensive disclosure of its full scope or all of its features.

In one aspect, a computer-implemented method is presented for refactoring software. The method includes: receiving a set of candidate solutions for refactoring the software, where each solution in the set of candidate solutions includes one or more refactor operations for the software; identifying a particular candidate solution from the set of candidate solutions, where the particular candidate solution includes refactor operations with highest commonality amongst the set of candidate solutions; presenting, by the computer processor, a particular refactoring operation from the particular candidate solution to a user; receiving feedback regarding the particular refactoring operation from the user; updating source code for the software based on the feedback from the user; and generating, by the computer processor, another set of candidate solutions using the updated source code, for example by applying a genetic algorithm to a set of candidate solutions and thereby yielding a next generation of candidate solutions.

In another aspect, a variant of the computer-implemented method for refactoring software is presented. In this variant, select candidate solutions are removed from the next generation of candidate solutions based on feedback from the user. For example, removing candidate solutions which include a particular refactoring operation, such as a refactoring operation rejected by the user.

In one embodiment, each candidate solution in the next generation of candidate solutions is evaluated according to two fitness functions, where one of the two fitness functions minimizes number of changes to the source code and other of the two fitness functions maximizes software quality.

Identifying a given candidate solution may include calculating a composite ranking score for each candidate solution in the set of candidate solutions, where the composite ranking score is calculated by computing a ranking score for each refactor operation in a given candidate solution based upon frequency of the refactor operation across the set of candidate solution; and summing the ranking score for each refactor operation in the given candidate solution to yield the composite ranking score, such that the particular candidate solution is the candidate solution having highest composite ranking score in the set of candidate solutions.

In one embodiment, a particular refactoring operation is presented by displaying an indicator to apply the particular refactoring operation to the software, an indicator to modify the particular refactoring operation and an indicator to reject the particular refactoring operation.

In response to receiving feedback from the user, a composite ranking score is recalculated for each candidate solution in the set of candidate solutions using the feedback from the user. The method continues by identifying another candidate solution from the set of candidate solutions, where the another candidate solution has highest composite ranking score after the step of recalculating a composite ranking score for each candidate solution in the set of candidate solutions; presenting a particular refactoring operation from the another candidate solution to a user; receiving feedback regarding the particular refactoring operation from the user; and recalculating a composite ranking score for each for each candidate solution in the set of candidate solutions using the feedback from the user. The steps are repeated until an exit condition is satisfied.

In the example embodiment, the composite ranking score for a given candidate solution is recalculated by adding one to the composite ranking score when the given candidate solution includes the particular refactoring operation and the feedback indicates to apply the particular refactoring operation to the software, by adding one half to the composite ranking score when the given candidate solution includes the particular refactoring operation and the feedback indicates to modify the particular refactoring operation, and by subtracting one to the composite ranking score when the given candidate solution includes the particular refactoring operation and the feedback indicates to reject the particular refactoring operation.

In another aspect, a variant of the computer-implemented method for refactoring software is presented. In this variant, select candidate solutions are removed from the next generation of candidate solutions based on feedback from the user. For example, removing candidate solutions which include a particular refactoring operation, such as a refactoring operation rejected by the user.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram providing an overview of the interactive software refactoring approach set forth in this disclosure

FIG. 2 is a flowchart depicting an interactive method for refactoring software;

FIG. 3 is a flowchart depicting a portion of the interactive method executed for a given set of candidate solutions.

FIG. 4 illustrates exemplar refactorings recommended by the interactive refactoring method.

FIG. 5 illustrates recommended target classes by the technique for a move method refactoring to modify.

FIGS. 6A-6C are a table depicting the Tukey post hoc analysis results between the interactive method and the other methods

FIG. 7A-7J are boxplots of G, NF, MC, PR, and RC on all the ten systems based on 30 independent runs; label of the methods: M1(proposed approach)=Interactive+Innovization NSGA-II, M2=Innovization NSGA-II, M3=Kessentini, M4=Ouni, M5=Harman, M6=O'Keeffe, M7=Jdeodorant

FIG. 8 is a graph showing MC@k results on the different systems with k=1, 5, 10 and 15, respectively.

FIG. 9 is a graph showing PR@k results on the different systems with k=1, 5, 10 and 15.

FIG. 10 is a graph showing the median NMR, NRR and NAR results in the different systems.

FIG. 11 is a graph showing the average productivity difference (TP) results on the different tasks performed by the three groups using the interactive approach, Quni et al., Harman et al.

FIGS. 12A and 12B illustrate the Gantt Options before and after refactoring.

Corresponding reference numerals indicate corresponding parts throughout the several views of the drawings.

### DETAILED DESCRIPTION

Example embodiments will now be described more fully with reference to the accompanying drawings.

Refactoring is defined as the process of improving the code after it has been written by changing its internal structure without changing its external behavior. The idea is to reorganize variables, classes and methods to facilitate future adaptations and enhance comprehension. This reorganization is used to improve different aspects of the software quality such as maintainability, extensibility, reusability, etc. Some modern Integrated Development Environments (IDEs), such as Eclipse, Netbeans, provide support for applying the most commonly used refactorings, e.g., move method, rename class, etc. Other types of IDEs are also contemplated by this disclosure.

In order to identify which parts of the source code need to be refactored, most of the existing work relies on the notion of bad smells, also called design defects or anti-patterns. In this disclosure, it is assumed that code smells have been already detected, and need to be corrected. Typically, code smells refer to design situations that adversely affect the development of the software. When applying refactorings to fix design defects, software metrics can be used as an overall indication of the quality of the new design. For instance, high intra-class cohesion and low inter-class coupling usually indicate a high-quality system. Different techniques for detecting code smells are known in the art and fall within the scope of this disclosure.

A brief overview is given about two important aspects in the Evolutionary Multi-objective Optimization (EMO) paradigm related to the: (1) interaction with the user and (2) dynamicity of the problem.

Interacting with the human user means allowing the user to inject his/her preferences into the computational search algorithm and then using these preferences to guide the search process. To express his/her preferences, the user needs some preference modeling tools. The most commonly used ones are:

Weights: Each objective is assigned a weighting coefficient expressing its importance. The larger the weight is, the more important the objective is.

Solution ranking: The user is provided with a sample of solutions (a subset of the current population) and is invited to perform comparisons between pairs of equally-ranked solutions in order to differentiate between solutions that the fitness function regards as equal.

Objective ranking: Pairwise comparisons between pairs of objectives are performed in order to rank the problem's objectives where strong conflict exists between a pair of objectives.

Reference point (also called a goal or an aspiration level vector): The user supplies, for each objective, the desired level that he/she wishes to achieve. This desired level is called aspiration level.

Reservation point (also called a reservation level vector): The user supplies, for each objective, the accepted level that he/she wishes to reach. This accepted level is called reservation level.

Trade-off between objectives. The user specifies that the gain of one unit in one objection is worth degradation in some others and vice versa.

Outranking thresholds: The user specifies the necessary thresholds to design a fuzzy predicate modeling the truth degress of the predicate solution x is at least as good as solution y.

Desirability thresholds: The user supplies: (1) an absolutely satisfying objective value and (2) a marginally infeasible objective value. These thresholds represent the parameters that define the desirability functions.

Based on these preference modeling tools, one observes that the goal of a preference-based EMO algorithm is to assign different importance levels to the problem's objectives with the aim to guide the search towards the Region of Interest (ROI) that is the portion of the Pareto Front that best matches the user preferences. In fact, usually, the user is not interested with the whole Pareto front and thus he/she is searching only for his/her ROI from which the problem's final solution will be selected. Several preference-based EMO algorithms have been proposed and used to solve real problems, including but not limited to PI-EMOA, iTDEA, NOSGA, and DF-SMS-EMOA. There are several algorithmic challenges that should be overcome such as the preservation of Pareto dominance, the preservation of population diversity, the scalability with the number of objectives, etc.

Until now, the user's preferences are expressed and handled in the objective space. It is important to highlight that one of the original aspects of the work in this disclosure, as detailed later, is allowing the user (a software developer) to express his/her preferences in the decision space and then handling these preferences to help the user finding the most desired refactoring solution. Moreover, this approach helps the user in eliciting his/her preferences, which is very important for any preference-based EMO algorithm. These preferences are introduced implicitly by moving between the Pareto front of non-dominated solutions after obtaining feedback from the user about just a few parts of the solution in order to better understand his preferences. This implicit exploration of the Pareto front will be detailed in the next section where the formulation of the refactoring problem is described.

The incorporation of user preferences may require the handling of dynamicity issues related to the introduced changes to the solution or the input (i.e. the software system). Handling dynamicity in EMO means solving dynamic problems where the objective functions and/or the constraints may change over time due to, for example, the dynamic nature of most of software evolution problems including software refactoring. Applying evolutionary algorithms (EAs) to solve Dynamic Multi-Objective Problems (DMOPs) has received great attention from researchers thanks to the adaptive behavior of evolutionary computation methods. A DMOP consists of minimizing or maximizing an objective function vector under some constraints over time. Its general form is the following:

$$\{ \begin{matrix}Min f ( x , t ) = {[ {f}_{1} ( x , t ) , {f}_{2} ( x , t ) , … , {f}_{M} ( x , t ) ]}^{T} & \\ {g}_{j} ( x , t ) \geq 0 , & j = 1 , … P ; \\ {h}_{k} ( x , t ) = 0 , & k = 1 , … Q ; \\ {x}_{i}^{L} \leq {x}_{i} \leq {x}_{i}^{U} , & i = 1 , … n ,\end{matrix} ;$$

where M is the number of objective functions, t is the time instant, P is the number of inequality constraints, Q is the number of equality constraints, Xᵢ^{L} and xᵢ^{U} correspond respectively to the lower and upper bounds of the variable xᵢ.

A solution x₁ satisfying the (P+Q) constraints is said to be feasible, and the set of all feasible solutions defines the feasible search space denoted by Ω. In this formulation, a minimization multi-objective problem is considered since maximization can be easily turned into minimization based on the duality principle by multiplying each objective function by −1 and transforming the constraints based on the duality rules.

The resolution of a multi-objective problem yields a set of trade-off solutions, called Pareto optimal solutions or non-dominated solutions, and the image of this set in the objective space is called the Pareto front. Hence, the resolution of a multi-objective problem consists in approximating the entire Pareto front. In the following, some background definitions are provided related to multi-objective optimization. It is worth noting that these definitions remain valid in the case of DMOPs.
Definition 1: Pareto optimality—A solution x* ∈ Ω is a Pareto optimal if ∀x ∈ 106 and I={1, . . . , M} either ∀m ∈ I we have ƒₘ(x)=ƒₘ(x*) or there is at least one m ∈ I such that ƒₘ(x)>ƒₘ (x*). The definition of Pareto optimality states the x* is Pareto optimal if no feasible vector exists that would improve some objectives without causing a simultaneous worsening in at least one other objective.
Definition 2: Pareto dominance—A solution u=(u₁, u₂, uₙ) is said to dominate another solution v=(v₁, v₂, . . . , vₙ) (denoted by ƒ(u) [symbol] ƒ(v)) if and only if ƒ(u) is partially less than ƒ(v). In other words, ∀m ∈ {1, . . . , M} we have ƒₘ (u)≤ƒₘ(v) and ∃m ∈ {1, . . . , M} where ƒₘ(u)<ƒₘ(v).
Definition 3: Pareto optimal set—For a given MOP ƒ(x), the Pareto optimal set is P*={x ∈Ω|¬∃x′ ∈Ω, ƒ(x′) [symbol] ƒ(x)}.
Definition 4: Pareto optimal front—For a given MOP ƒ(x) and its Pareto optimal set P*, the Pareto front is PF*={ƒ(x), x ∈ P*}.
   While particular reference is made to solving dynamic multi-objective problems, the interactive concepts for exploring the Pareto front are not limited to multi-objective problems.

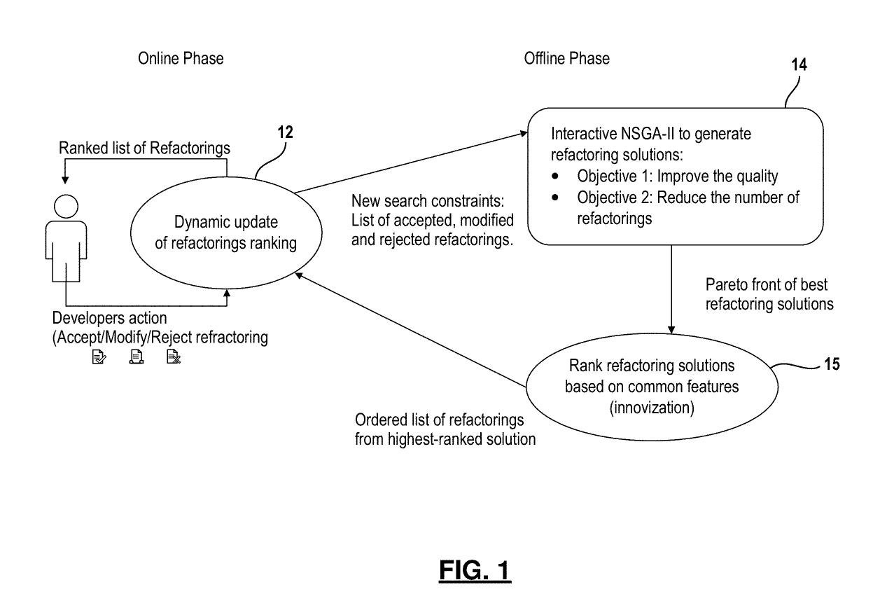

FIG. 1 illustrates the general approach set forth in this disclosure. The technique comprises two main components. The first component is an offline phase, executed in the background, when developers are modifying the source code of the system. During this phase, the multi-objective algorithm, NSGA-II, is executed for a number of iterations to find the non-dominated solutions balancing the two objectives of improving the quality, which corresponds to minimizing the number of code smells, maximizing/preserving the semantic coherence of the design and improving the QMOOD (Quality Model for Object-Oriented Design) quality metrics, and the second objective of minimizing the number of refactorings in the proposed solutions. In the example embodiment, the mufti-objective algorithm is the multi-objective evolutionary algorithm, NSGA-II, as described by Deb, K. et al in “A Fast and Elitist Multiobjective genetic Algorigm: NSGA-II” IEEE Transactions on Evolutionary Computations 6(2): 182-197 (2002) which is incorporated here in its entirety by reference. While reference is made to this particular algorithm, other types of genetic algorithms as well as other types of multi-objective algorithms fall within the scope of this disclosure,

The output of this first step of the offline phase is a set of Pareto-equivalent refactoring solutions that optimizes the above two objectives. The second step of the offline phase explores this Pareto front in an intelligent manner using innovization 14 to rank recommended refactorings based on the common features between the non-dominated solutions. In this adaptation, it is assumed that the most frequently occurring refactorings in the non-dominated solutions are the most important ones. Thus, the output of this second step of the offline phase is a set of ranked solutions 15 based on this frequency score. In the example embodiment, NSGA-II is able to generate not only one good refactoring solution, but a diverse set of non-dominated solutions. This set of refactoring solutions may include specific patterns that make them better and different than dominated (imperfect) refactoring solutions. To extract these patterns, the heuristic of prioritizing the recommendation of refactorings that are the most redundant ones among the non-dominated solutions is used. To intuition, it seems very likely that common patterns in the set of non-dominated solutions are very likely to be good patterns. The opposite situation, where some non-dominated solutions share a pattern that is of poor quality, seems highly unlikely, though it could plausibly occur were the poor quality pattern to be an essential enabling feature for another pattern of high quality. While only expressing an intuition here, innovization has proven itself to be of value later in the experiments section.

The second component of the approach is an online phase to manage the interaction with the developer. It dynamically updates the ranking of recommended refactorings at 12 based on the feedback of the developer. In one example, this feedback can be to approve/apply or modify or reject the suggested refactoring one by one as a sequence of transformations. Thus, the goal is to guide, implicitly, the exploration of the Pareto front to find good refactoring recommendations.

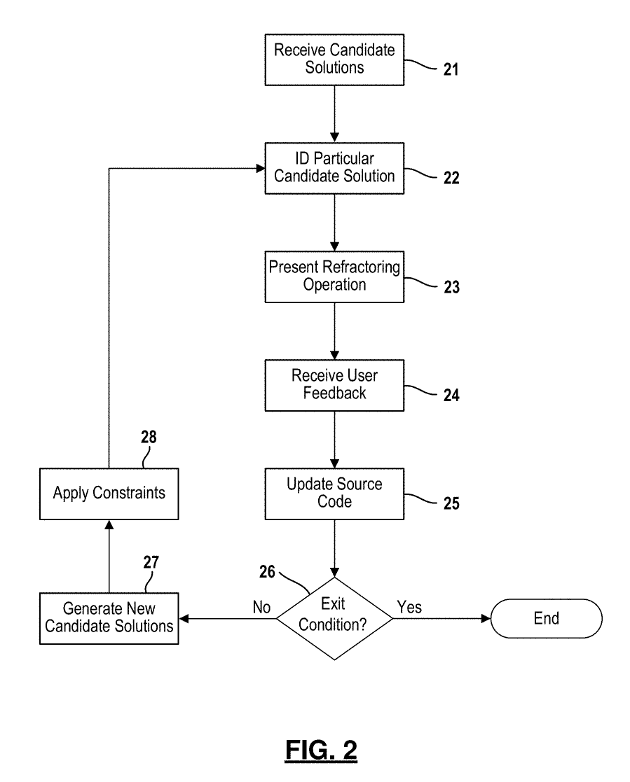

FIG. 2 further depicts the interactive method for refactoring software. Assuming at least one execution of a genetic algorithm, a set of candidate solutions for the refactoring the software, along with the source code of the software of interest, serves as an input to the interactive method as indicated at 21. Each candidate solution in the set of candidate solutions includes one or more recommended refactor operations for the software.

From amongst the set of candidate solutions, a particular candidate solution is identified at 22, where the particular candidate solution includes refactor operations with highest commonality amongst the set of candidate solutions. In one example, a ranking score for each refactor operation in a given candidate solution is computed based upon frequency of the refactor operation across the set of candidate solution. The ranking score for each refactor operation in the given candidate solution is then summed to yield a composite ranking score for the given candidate solution. The particular candidate solution is selected as the candidate solution having highest composite ranking score in the set of candidate solutions. Other techniques for assessing commonality of refactors operations are envisioned by this disclosure.

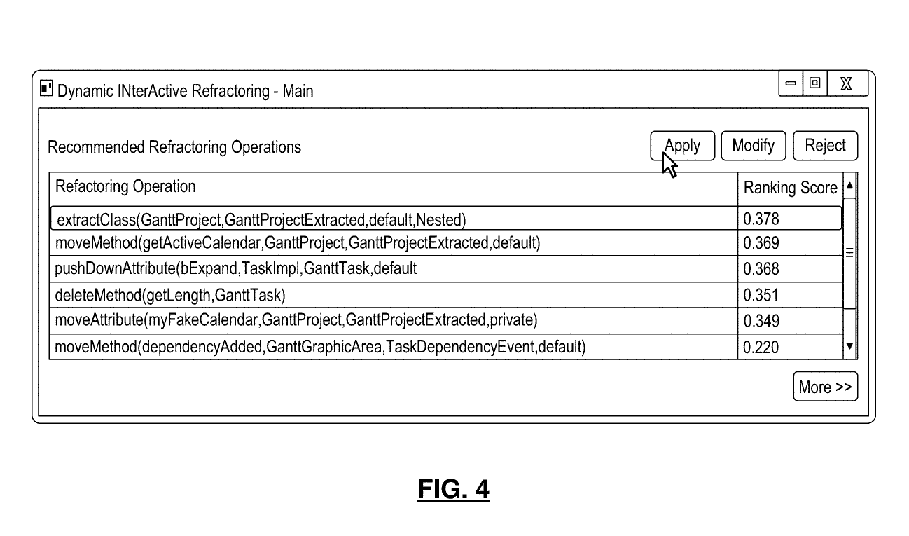

One or more refactoring operations from the particular candidate solution are then presented at 23 to a user, for example by displaying the refactor operation on a display of the system. In the example embodiment, the refactor operation is displayed with an indicator to apply the particular refactoring operation to the software, an indicator to modify the particular refactoring operation and an indicator to reject the particular refactoring operation, for example as seen in FIG. 4. The user in turn provides feedback regarding the particular refactoring operation.

Upon receipt of the feedback from the user at 24, the source code for the software is updated at 25 based on the feedback provided by the user. For example, the source code is modified to implement the refactor operation when the feedback indicates that the user accepts or want to apply the particular refactoring operation to the software. Once the developers approve some of the recommended refactorings, a set of routines/templates are executed, taking as input the current state of the code and the list of recommended refactorings, to generate the update refactored source code after checking a set of pre/post conditions to make sure that the source code compiles after refactoring. Update routines/templates are commonly found in commercial available integrated development environments.

This interactive approach for refactoring software can be iterative at a macro level. That is, the process is repeated until an exit condition is met as indicated at 26. In one example, the user merely indicates whether they are satisfied with the updated software and the process is terminated. If the user remains unsatisfied with the updated software, a new set of candidate solutions are generated at 27, for example by applying the genetic algorithm and thereby yielding a next generation of candidate solutions.

Previously rejected refactoring operations should not be considered during the subsequent iteration. Thus, select candidate solutions are removed from the next generation of candidate solutions at step 28. More specifically, candidate solutions which include at least one refactoring operation that was rejected by the user are removed from the next generation of candidate solutions.

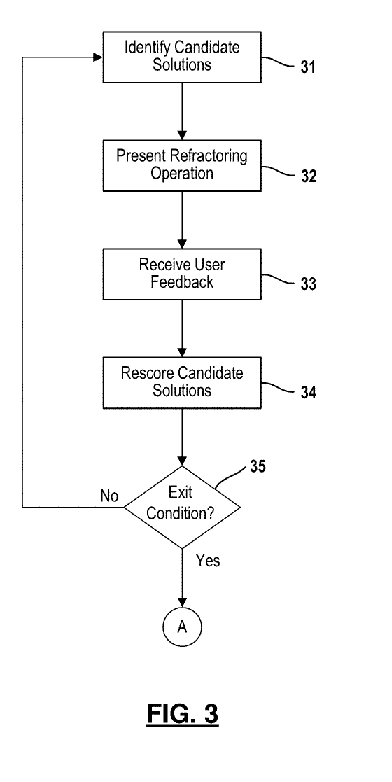

With the context of a set of candidate solutions, the interactive approach for refactoring software can also be iterative at a micro level as described in relation to FIG. 3. Starting with a set of candidate solutions, the interactive session with the user starts by selecting a particular candidate solution at 31, where the particular candidate solution includes refactor operations with highest commonality amongst the set of candidate solutions as described above in relation to step 22. Likewise, the interactive session presents one of refactoring operations from the particular candidate solution to a user at 32 and in turn receives user feedback for the particular candidate solution at 33. These three steps are the same as steps 22, 23 and 24 of FIG. 2.

Next, each of the candidate solutions in the set of candidate solutions is rescored based on the user feedback. Based on the updated ranking of the candidate solutions and the refactoring operations associated therewith, the interactive process is repeated until an exit condition is met as indicated at 35. In one example, there are two exit conditions. The first condition is when the developer decides to stop the interactive refactoring solution, for example to focus on functional changes. The second condition is when the composite ranking score for one or more of the candidate solutions becomes a negative value. In this case, it is desirable to re-execute the genetic algorithm to generate a new set of candidate solutions based on the user feedback. Other types of exit conditions are contemplated by this disclosure. Since the rankings are updated dynamically, the interactive approach implicitly moves between non-dominated solutions of the Pareto front. Once an exit condition is met, the source code can be updated and a new set of candidate solutions may be generated. Upon the occurrence of an exit condition at step 35, the interactive process continues at step 25 of FIG. 2 in the example embodiment.

With continued reference to FIG. 1, after a number of interactions, developers may have modified or rejected a high number of suggested refactorings or have introduced several new code changes (new functionalities, fix bugs, etc.). Whenever the developers stop the refactoring session by closing the suggestions window, the first component of the approach is executed again in the background to update the last set of non-dominated refactoring solutions, for example by continuing the execution of NSGA-II based on the two objectives defined in the first component but also the new constraints summarizing the feedback of the developer. In fact, the rejected refactorings by the developer is considered as constraints to avoid generating solutions containing several already rejected refactorings. This may lead to reducing the search space and thus a fast convergence to better solutions. Of course, the continuation of the execution of the genetic algorithm takes as input the updated version of the system after the interactions with developers. The whole process continues until the developers decide that there is no necessity to refactor the system any further.

Below an example embodiment of the interactive software refactoring method is described in greater detail. Algorithm 0 is the main loop in the interactive approach. Input is the source code for the target software and the output is the refactored software. This main loop calls Algorithm 1 as indicated at line 3. The main loop is executed until the user is satisfied with the refactored software or the current recommendations are not helpful and require repairs. Pseudo code for the main loop is as follows.

Algorithm 0: Main algorithm of the Interactive Refactoring approach

| | | |
|---|---|---|
| Input | : | Software System (sys) |

| | |
|---|---|
| Output: | Refactored System (refsys) |

| | |
|---|---|
| 1 | begin |

| | |
|---|---|
| 2 | while ¬ user is satisfied OR interactionScore < 0 do |

| | |
|---|---|
| // | Execute the Interactive Dynamic Multiobjective |

Algorithm with user preferences

| | |
|---|---|
| 3 | Run Algorithm 1( ): |

| | |
|---|---|
| 4 | Return refsys; |

In the example embodiment, a solution consists of a sequence of n refactoring operations involving one or multiple source code elements of the system to refactor. The vector-based representation is used to define the refactoring sequence. Each vector's dimension has a refactoring operation and its index in the vector indicates the order in which it will be applied. For every refactoring, pre- and post-conditions are specified to ensure the feasibility of the operation.

The initial population is generated by randomly assigning a sequence of refactorings to a randomly chosen set of code elements, or actors. The type of actor usually depends on the type of the refactoring it is assigned to and also depends on its role in the refactoring operation. An actor can be a package, class, field, method, parameter, statement or variable. Table 1 below depicts, for each refactoring, its involved actors and its corresponding parameters.

TABLE 1
List of considered refactorings for the solution representation

| Refactorings | Actors | Roles |
|---|---|---|
| Extract class | class | source class, new class |
| | field | moved fields |
| | method | moved methods |
| Extract interface | class | source class, new interface |
| | method | moved abstract methods |
| Inline class | class | source class, target class |
| Move field | class | source class, target class |
| | field | moved field |
| Move method | class | source class, target class |
| | method | moved method |
| Push down field | class | super class, subclasses |
| | field | moved field |
| Push down method | class | super class, subclasses |
| | method | moved method |
| Pull up field | class | subclasses, super class |
| | field | moved field |
| Pull up method | class | subclasses, super class |
| | method | moved method |
| Move class | package | source package, target package |
| | class | moved class |
| Extract method | method | source class, new class |
| | field | moved fields |

These refactorings are merely exemplars and not intended to be limiting of the types of refactorings implemented by the system.

The size of a solution, i.e. the vector's length is randomly chosen between upper and lower bound values. The determination of these two bounds is similar to the problem of bloat control in genetic programming where the goal is to identify the tree size limits. Since the number of required refactorings depends mainly on the size of the target system, for each target project performed, several trial and error experiments using the HyperVolume (HV) performance indicator to determine the upper bound after which, the indicator remains invariant. For the lower bound, it is arbitrarily chosen. The experiments section will specify the upper and lower bounds used in this study. Table 2 shows an example of a refactoring solution including three operations applied to a simplified version of a solution applied to JVacation v1.0, a Java open-source trip management and scheduling software.

TABLE 2
Example of a solution representation

| Operation | Source/entity | Target entity |
|---|---|---|
| Move Method | ctrl.booking.BookingController::handleLodgingViewEvent | ctrl.booking.LodgingModel |
| | (java.awt.event.ActionEvent):void | |
| Extract Class | ctrl.booking.SelectionModel::-flightList + addFlight( ):void + | ctrl.booking.FlightList |
| | clearFlight( ):void | |
| Move Method | ctrl.booking.BookingController::createBookings( ):void | ctrl.CoreModel |

Algorithm 1 is primarily concerned with generating a set of candidate solutions for refactoring the target software. The first iteration of the algorithm identifies the Pareto front of the non-dominated refactoring solutions based on the fitness functions described below. Subsequent iterations use interaction data from the user to reduce the search space of possible refactoring solutions and improve the future suggestions by repairing the Pareto front. Psuedo code for this primary algorithm is set forth below.

Algorithm 1 Dynamic Interactive NSGA-II at generation t

| | |
|---|---|
| 1: | Input |
| 2: | Sys: system to evaluate, Pt: parent population |
| 3: | Output |
| 4: | Pt+l |
| 5: | Begin |
| 6: | /* Test if any user interaction occurred in the previous |

iteration * /

| | |
|---|---|
| 7: | if UserFeedback = TRUE then |

| | |
|---|---|
| 8: | /* Rejected refactoring operations as constraints */ |
| 9: | Ct ← GetConstraints( ); |
| 10: | /* Updated source code after applying changes */ |
| 11: | Sys GetRefactored ← System ( ); |
| 12: | UserFeedback ← FALSE; |

| 13: | end if | |
|---|---|---|
| 14: | Sₜ ← Ø, i ← 1; | |
| 15: | Qₜ ← Variation (Pₜ); | |
| 16: | Rₜ ← PₜU Qₜ; | |
| 17: | Pₜ ← evaluate(Pₜ,Cₜ, Sys); | |
| 18: | (F₁, F₂, ...) | ← NonDominatedSort(Rₜ); |

| | |
|---|---|
| 19: | repeat |

| | |
|---|---|
| 20: | Sₜ ← Sₜ ∪ Fᵢ; |
| 21: | i + i + 1 |

| 22: | until (\|Sₜ\| ≥ N) | |
|---|---|---|
| 23: | Fₗ ← Fᵢ; | →//Last front to be included |

| | |
|---|---|
| 24: | if \|Sₜ\| = N then |

| | |
|---|---|
| 25: | Pₜ₊₁ ← Sₜ; |

| | |
|---|---|
| 26: | else |

| | |
|---|---|
| 27: | Pₜ₊₁ ←Uⱼ₌₁^{l-1} Fⱼ; |
| 28: | /*Number of points to be chosen from Fₗ*/ |
| 29: | K ← N − \|Pₜ₊₁\|; |
| 30: | /*Crowding distance of points in Fl*/ |
| 31: | Crowding − Distance − Assignment(F₁); |
| 32: | Quick − Sort(F₁); |
| 33: | /*Choose K solutions with largest distance*/ |
| 34: | Pₜ+₁ ← Pₜ₊₁ U Select(Fₗ, k); |

| | |
|---|---|
| 35: | end if |
| 36: | if t + 1 = Threshold then |

| | |
|---|---|
| 37: | UserFeedback ← TRUE; |
| 38: | /* Select and rank the best front */ |
| 39: | Rank − Solution(F₁); |
| 40: | Threshold ← Threshold + t + 1; |

| | |
|---|---|
| 41: | end if |
| 42: | End |

Initially, a determination is made as to whether any user interaction occurred in a previous iteration as indicated at line 7. If feedback is available from a previous iteration, rejected refactoring operations are set as constraints for the genetic algorithm and the source code is updated based on the user feedback.

Next, the genetic algorithm is executed as seen in lines 14-35. In each search algorithm, the variation operators used at line 15 play the key role of moving within the search space with the aim of driving the search towards optimal solutions.

For the crossover, a one-point crossover operator is used in the example embodiment. It starts by selecting and splitting at random two parent solutions. Then, this operator creates two child solutions by putting, for the first child, the first part of the first parent with the second part of the second parent, and vice versa for the second child. This operator must ensure the respect of the length limits by eliminating randomly some refactoring operations. It is important to note that in multi-objective optimization, it is better to create children that are close to their parents in order to have a more efficient search process. For mutation, the bit-string mutation operator is used that picks probabilistically one or more refactoring operations from the solutions and replace or modify or delete them. While the crossover operator does not introduce or modify a refactoring of a solution but just the sequence (a swap between refactoring of different solutions), the mutation operator definitely can add or modify or delete a refactoring when applied to any solution of the population. When a mutation operator is applied, the goal is to slightly change the solution for the purpose to probably improve its fitness functions. Three operations are used for the mutation operator that are randomly selected when a mutation is applied to a solution. Thus, the mutation operator can introduce new refactorings by either adding completely new ones or modifying the controlling parameters of an existing refactoring. For example, move method (m1, A, B) could be replaced by movemethod(ml, A, C) or movemethod(m3, A, B), where ml, A and B are the controlling parameters of the refactoring move method. Furthermore, the selection operator allows to regenerate part of the population randomly at every iteration thus new refactoring will be introduced since new solutions are generated during the execution process.

When applying the change operators, the different pre- and post-conditions are checked to ensure the applicability of the newly generated solutions. For example, to apply the refactoring operation movemethod a number of necessary pre-conditions should be satisfied such as the method and the source and target classes should exists. A post-condition example is to check that the method exists and was moved to the target class and did not exist anymore in the source class. More details about the adapted pre- and post-conditions for refactors are described by M. Fowler et al can in Refactoring: Improving the design of existing programs'. Proc. Conference Name, Conference Location, 1999. A repair operator that randomly selects new refactorings to replace those creating conflicts can also be applied.

The generated solutions are evaluated at line 17 using two fitness functions: minimize the number of code changes and maximize software quality. With regard to minimizing the number of code changes as an objective, the application of a specific suggested refactoring sequence may require an effort that is comparable to that of re-implementing part of the system from scratch. Taking this observation into account, it is essential to minimize the number of suggested operations in the refactoring solution since the designer may have some preferences regarding the percentage of deviation with the initial program design. In addition, most developers prefer solutions that minimize the number of changes applied to their design. Thus, it is formally defined the fitness function as the number of modified actors/code elements (packages, classes, methods, attributes) by the generated refactorings solution

ƒ(x)=Σᵢ₋₁ⁿ#code_elements(Rᵢ, x) (1)

where x is the solution to evaluate, n is the number of refactorings in the solution x and #code_elements is a function that counts the number of modified code elements in a refactoring. Any solution with refactorings being performed on the same code elements will have better (lower) fitness value for this objective. Such a definition of the objective is in favor of code locality since it encourages refactoring the same code fragment, as developers prefer to refactor the specific elements with which they are most familiar instead of applying scattered changes throughout the whole system. The proposed fitness function is different from that employed in the previous work where only the number of applied refactorings are counted. In fact, each refactoring type may have a different impact on the system in terms of number of code changes it engenders, something that can be identified using the new formulation.

With regard to maximizing software quality as an objective, many studies have utilized structural metrics as a basis for defining quality indicators for a good system design. As an illustrative example, a proposed a set of quality measures, using the ISO 9126 specification, called QMOOD is described by J. Bansiya et al. in “A hierarchical model for object-oriented design quality assessment. IEEE Transactions on Software Engineering”. 28(1): 4-17.′ (2002). Each of these quality metrics is defined using a combination of low-level metrics as detailed in Tables 3 and 4.

TABLE 3
QMOOD metrics description.

| Design Metric | Design Property | Description |
|---|---|---|
| Design Size in | Design Size | Total number of classes in the |
| Classes (DSC) | | design. |
| Number Of | Hierarchies | Total number of “root” classes in |
| Hierarchies | | the design |
| (NOH) | | (counKMaxInheritenceTree |
| | | (class) = 0» |
| Average Number | Abstraction | Average number of classes in |
| of Ancestors | | the inheritance tree for each |
| (ANA) | | class |
| Direct Access | Encapsulation | Ratio of the number of private |
| Metric (DAM) | | and protected attributes to the |
| | | total number of attributes in a |
| | | class. |
| Direct Class | Coupling | Number of other classes a class |
| Coupling | | relates to, either through a |
| (DCC) | | shared attribute or a parameter |
| | | in a method. |
| Cohesion | Cohesion | Measure of how related methods |
| Among | | are in a class in terras of used |
| Methods of | | parameters. |
| class (CAMC) | | It can also be computed by: |
| | | 1 - LackOfCohesionOfMethodsO |
| Measure Of | Composition | Count of number of attributes |
| Aggregation | | whose type is user defined |
| (MOA) | | class(es). |
| Measure of | Inheritance | Ratio of the number of inherited |
| Functional | | methods per the total number of |
| Abstraction | | methods within a class. |
| (MFA) | | |
| Number of | Polymorphism | Any method that can be used by |
| Polymorphic | | a class and its descendants. |
| Methods (NOP) | | Counts of the number of |
| | | methods in a class excluding |
| | | private, static and final ones. |
| Class Interface | Messaging | Number of public methods in class. |
| Size (CIS) | | |
| Number of | Complexity | Number of methods declared in a |
| Methods (NOM) | | class. |

TABLE 4
Quality attributes and their computation equations.

| | Definition |
|---|---|
| Quality attributes | Compulation |
| Reusability | A design with low coupling and high cohesion |
| | is easily reused by other designs. |
| | −0.25 * Coupling + 0.25 * Cohesion + 0.5 * |
| | Messaging + 0.5 * DesignSize |
| Flexibility | The degree of allowance of changes in the |
| | design. |
| | 0.25 * Encapsulation − 0.25 *Coupl mg + 0.5* |
| | Composition + 0.5 * Polymorphism |
| Understandability | The degree of understanding and the easiness |
| | of learning the design [symbol] |
| | 0.33 * Abstraction + 0.33 * Encapsulation − 0.33 * |
| | Coupling + 0.33 * Cohesion − 0.33 * |
| | Polymorphism − 0.33 * Complexity − 0.33 * |
| | DesignSize |
| Functionality | Classes with given functions that are |
| | publicly stated in interfaces to be used by [symbol] |
| | 0.12 * Cohesion + 0.22 * Polymorphism + 0.22* |
| | Messaging + 0.22* DesignSize −\0.22* Hierarchies |
| Extendibility | Measurement of design's allowance to |
| | incorporate new functional requirements. |
| | 0.5 * Abstraction − 0.5 * Coupling + 0.5 * |
| | Inheritance + 0.5 * Polymorphism |
| Effectiveness | Design efficiency in fulfilling the required |
| | functionality. |
| | 0.2 * Abstraction + 0.2 * Encapsulation + 0.2 * |
| | Composition + 0.2 * Inheritance + 0.2 * |
| | Polymorphism |

[symbol]

indicates data missing or illegible when filed

The QMOOD model has been used previously in the area of search-based software refactoring and so it is used to estimate the effect of the suggested refactoring solutions on software quality. QMOOD has the advantage that it defines six high-level design quality attributes (reusability, flexibility, understandability, functionality, extendibility, and effectiveness) that can be calculated using 11 lower level design metrics. Its objective function is defined as:

$$Quality = \frac{{\sum }_{i = 1}^{6} {QA}_{i} ( S )}{6} \qquad ( 2 )$$

where QAᵢ is the quality attribute number i being calculated based on the returned structural metrics from the system S.

Since it may not be sufficient to consider structural metrics, the design coherence measures of a previous work is used to ensure that every refactoring solution preserves the semantics of the design. The assumption starts that the vocabulary of an actor is borrowed from the domain terminology and therefore can be used to determine which part of the domain semantics an actor encodes. Thus, two actors are likely to be semantically similar if they use similar vocabularies.

The vocabulary can be extracted from the names of methods, fields, variables, parameters, types, etc. The design coherence similarity is calculated between actors using an information retrieval-based technique, namely cosine similarity. Each actor is represented as an n-dimensional vector, where each dimension corresponds to a vocabulary term. The cosine of the angle between two vectors is considered as an indicator of similarity.

With continued reference to Algorithm 1, the interactive component of the algorithm is executed at line 39. The interactive component encompasses executing Algorithm 2 and Algorithm 3 in succession. In an example embodiment, the interactive component is executed so long as a number of interactions remains less than a threshold.

Algorithm 2 investigates if there are some common principles among the generated non-dominated refactoring solutions.

Algorithm 2 Rank Refactoring Operation procedure

| | |
|---|---|
| 1: | Input |
| 2: | NS: Non-dominated SolutionSet of the first front |
| 3: | Output |
| 4: | HM: HashMap of refactorings along with their occurrences. |
| 5: | Begin |
| 6: | HM← Ø; |
| 7: | /*Compute the number of occurrence of each refactoring operation*/ |
| 8: | for i=1 to \|NS\| do |

| | |
|---|---|
| 9: | for each j=1 to \|NSᵢ\| do |

| | |
|---|---|
| 10: | /*If a refactoring operation does not exist in the list, |
| | add its hash and set its occurrence number to 1*/ |

| | |
|---|---|
| 11: | if (NS_{i,j} ∉ HM) then |

| | |
|---|---|
| 12: | HM ← HM ∪ Hash (NS_{i,j}); |
| 13: | HM[Hash(NS_{i,j})] ← 1; |
| 14: | /* If a refactoring operation exists in the list, |
| | increment its occurrence number */ |

| | |
|---|---|
| 15: | else |

| | |
|---|---|
| 16: | HM[Hash(NS_{i,j})] ← HM [Hash(NS_{i,j})] + 1 |

| | |
|---|---|
| 17: | end if |

| | |
|---|---|
| 18: | end for |

| | |
|---|---|
| 19: | end for |

| | |
|---|---|
| 20: | End |

The algorithm checks if the optimal refactoring solutions have some common features such as identical refactoring operations among most or all of the solutions, and a specific common order/sequence in which to apply the refactorings. To so do, a composite ranking score is calculated for each candidate solution in the set of candidate solutions, where the composite ranking score is calculated by computing a ranking score for each refactor operation in a given candidate solution based upon frequency of the refactor operation across the set of candidate solution and summing the ranking score for each refactor operation in the given candidate solution to yield the composite ranking score. This example ranking calculation is set forth below.

$$Rank ( {R}_{x , y} ) = \frac{{\sum }_{j = 0}^{n} {\sum }_{i = 0}^{size ( {S}_{j} )} [ {R}_{i , j} = {R}_{x , y} ]}{MAX ( {\sum }_{j = 0}^{n} {\sum }_{i = 0}^{size ( {S}_{j} )} [ {R}_{i , j} = {R}_{x , y} ] )} ∈ [ 0 … 1 ] \qquad ( 3 )$$

where R_{x,y} is the refactoring operation number x (index in the solution vector) of solution number y,and n is the number of solutions in the front. Sᵢ is the solutionof index i. All the solutions of the Pareto front are ranked based on the score of this measure applied to every solution.

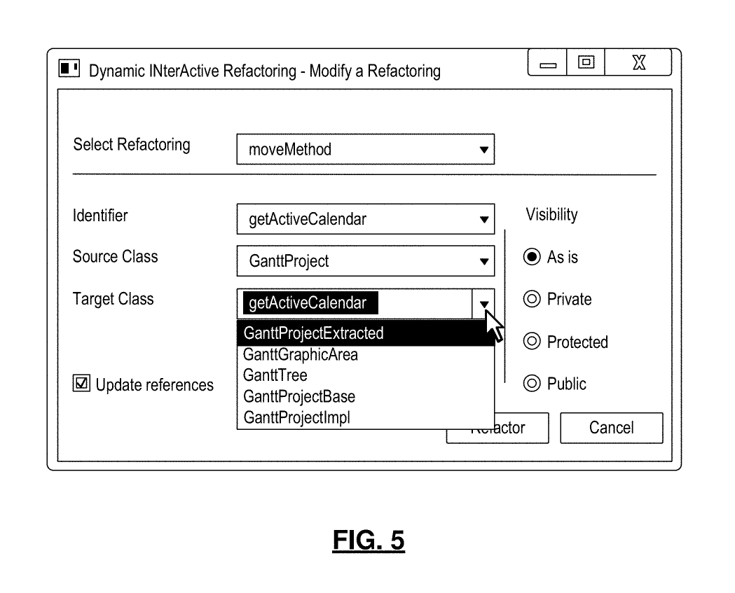

Once the Pareto front solutions are ranked, the second step of the interactive step is executed as described in Algorithm 3. The refactorings of the best solution, in terms of ranking, are recommended to the developer based on their order in the vector. In one example, the candidate solution having the highest composite ranking score in the set of candidate solutions is presented to the user as indicated at line 14. In the example embodiment, the developer can review the ranked list of refactorings and then apply, modify or reject the refactoring. If the developer prefers to modify the refactoring, then the algorithm can help them during the modification process as shown in FIG. 5.

In fact, the tool proposes to the developer a set of recommendations to modify the refactoring based on the history of changes applied in the past and the semantic similarity between code elements (classes, methods, etc.). For example, if the developer wants to modify a move method refactoring then, having specified the source method to move, the interactive algorithm automatically suggests a list of possible target classes ranked based on the history of changes and semantic similarity. This is an interesting feature since developers often know which method to move, but find it hard to determine a suitable target class. The same observation is valid for the remaining refactoring types. Another action that the developers can select is to reject/delete a refactoring from the list.

After every action selected by the developer, the ranking is updated based on the user feedback as indicated at line 26. That is, in response to receiving feedback from the user, a composite ranking score is recalculated for each candidate solution in the set of candidate solutions using the feedback from the user. In the example embodiment, the composite rank score for a given candidate solution is updated as follows:

$$Rank ( {S}_{i} ) = {\sum }_{k = 1}^{size ( {S}_{i} )} Rank ( {R}_{k , i} ) + ( RO ⋂ AppliedRefactoringsList ) - ( RO ⋂ RejectedRefactoringsList ) + 0.5 * ( RO ⋂ ModifiedRfactoringsList ) \qquad ( 4 )$$

where Sᵢ is the solution to be ranked, the first component consists of the sum of the ranks of its operations as explained previously and the second component will take the value of 1 if the recommended refactoring operation was applied by the developer, or −1 if the refactoring operation was rejected or 0.5 if it was partially modified by the developer. The recommended refactorings will be adjusted based on the updated ranking score.

It is important to note that the ranking score for each non-dominated solution is calculated using the innovization component and then the solution with the highest score is presented to the developer. In fact, refactorings tend to be dependent on one another thus it is important to ensure the coherence of the recommended solution.

After a number of modified or rejected refactorings or several new code changes introduced, the generated Pareto front of refactoring solutions needs to be updated since the system was modified in different locations. In this example, refactorings from the best ranked solution are presented to the user until the number of rejected refactoring operations exceeds a threshold as indicated at line 12. Processing then returns back to complete Algorithm 1.

To check the applicability of the refactorings, the pre-conditions of individual refactorings on the version are continuously checked after manual edits. Thus, the ranking of the solutions will change after every interaction. If many refactorings are rejected, the NSGA-II algorithm will continue to execute while taking into consideration all the feedback from developers as constraints to satisfy during the search. The rejected refactors should not be considered as part of the newly generated solutions and the new system after refactoring will be considered in the input of the next iteration of the NSGA-II.

In non-interactive refactoring systems, the set of refactorings, suggested by the best-chosen solution, needs to be fully executed in order to reach the solution's promised results. Thus, any changes applied to the set of refactorings such as changing or skipping some of them could deteriorate the resulting system's quality. In this context, the goal of this disclosure is to cope with the above-mentioned limitation by granting to the developer's the possibility to customize the set of suggested refactorings either by accepting, modifying or rejecting them. One novelty of this disclosure is the approach's ability to take into account the developer's interaction, in terms of introduced customization to the existing solution, by conducting a local search to locate a new solution in the Pareto Front that is nearest to the newly introduced changes. It is believed that the approach may narrow the gap that exists between automated refactoring techniques and human intensive development. It allows the developer to select the refactorings that best matches his/her coding preferences while modifying the source code to update existing features.

To illustrate the interactive algorithm, the refactoring of JVacation v1.0 (https://sourceforge.net/projects/jvacation), a Java open-source trip management and scheduling software is considered. A developer updated an existing feature by adding one more field (Premium member ID) in the personal information form that a user has to fill out when booking a flight.

As JVacation architecture is based on the Model/View/Controller model, adding this extra field would trigger small updates on the View by adding a textbox in the personal information input form, Also the controller that handles the booking process needs to be revised. At the model level, an attribute needs to be added to the class that hosts the booking information. Finally, an update on the database level is needed to save the newly modified booking objects.

To simplify the illustration, the update has been limited to these above-mentioned changes knowing that, in order to completely implement this function, several other updates may be needed in other views and controllers in order to show, for example, the newly added field, as part of the information related to the passengers' records for a given flight. The developer was asked to refactor the software system while performing the given task, therefore, the developer has initially launched the plugin that triggered the interactive algorithms. The developer was assisted in only selecting the initial default parameters for the optimization algorithm (such as the minimum and maximum chromosome lengths).

After generating the upfront list of best refactoring solutions, three solutions are selected from the Pareto front that were involved in the interactive session to simplify this running example. Each solution has a fitness score composed of the median of quality improvement calculated based on the structural measures of the refactored system for each solution, and the number of operations within each solution. The previous section describes, these fitness values, for each solution, in terms of quality improvement and refactoring effort compared to the original system values before refactoring. This information is shown in Table 5.

TABLE 5
Quality attributes value on the JVacation system.

| | Original | | | |
|---|---|---|---|---|
| Quality Attribute | System | Solution 1 | Solution 2 | Solution 3 |
| Reusability | 1.74225 | (+0.5) | (+0.4) | (+0.5) |
| | | 1.79225 | 1.79225 | 1.79225 |
| Flexibility | 1.82 | (+0.001) | (+0.001) | (+0.001) |
| | | 1.820 | 1.820 | 1.820 |
| Understandability | −4.5408 | (+0.08) | (+0.07) | (+0.087) |
| | | −4.5398 | −4.5398 | −4.5398 |
| Functionality | 1.16314 | (+0.5) | (+0.6) | (+0.5) |
| | | 1.21314 | 1.21314 | 1.21314 |
| Extendibility | 19.7225 | (+0.007) | (+0.012) | (+0.011) |
| | | 19.7295 | 19.7300 | 19.7299 |
| Effectiveness | 9.5406 | 9.5406 | 9.5406 | 9.5406 |
| Quality Gain | — | 0.198 | 0.202 | 0.209 |
| Number of operations | — | 11 | 14 | 19 |

One of the classic challenges in multi-objective optimization is the choice of the most suitable solution for the developer. The straightforward solution for this problem would be to manually investigate all solutions, i.e., execute all refactoring operations for each solution and allow the developer to compare between several refactored designs. This task can easily become tedious due to the large number of solutions in the Pareto front.

To facilitate the selection task, decision making support tools can be used to automate the selection of solutions based on the decision maker's preferences. In the context, these preferences can be considered as the packages and classes that the developer is interested in when implementing the requested feature. Thus, another straightforward heuristic would be to automatically shortlist solutions that only refactor entities that are of interest to developers. Unfortunately, this will not necessarily reduce drastically the number of preferred solutions especially if the system is small.

To cope with this issue, another interesting idea would be to calculate the overlap between solutions. Still, choosing the most appropriate solution can be challenging as the developer has to manually break the tie between solutions by comparing between their specific refactorings. This comparison may not be straightforward because specific refactorings between to candidate solutions may both be of an interest to the developer, for example, when comparing between solution 1 and solution 2, both solutions contain a move-method operation that agree on moving a function called getSaluation( ) but disagree on the target class.

Since this function belongs to the booking panel, the participating entities are of interest to the developer, so no choice can be automatically done based on the developer's preferred entities. Moreover, both target classes (respectively LabelSpinner and LabelEdit), each proposed by one solution, belong to the same package (gui.components) and they are semantically close, so the fitness function values cannot be used to break the tie. In this scenario, only the developer would be qualified to take the decision of either accepting one operation over the other or maybe rejecting both operations. Thus, simply filtering solutions based on the developer's preferred entities may fall short in this kind of scenarios. Furthermore, asking the developer to exhaustively break the tie between shortlisted solutions can become tedious.

In this context, the interactive process differs from simply filtering operations based on a given preference as it learns from the developer's decision making and dynamically break the tie between Pareto-equivalent solutions by up-grading those with the highest number of successful recommendations (applied refactorings) while penalizing those who contain rejected operations, To illustrate this process, Table 6 describes each solution's refactorings along with its rank after the execution of the first step of the interactive algorithm. For the purpose of simplicity, a first fragment of each solution is considered. The solutions are ranked based on Equation 3 to identify the most common refactorings between the non-dominated solutions. This is achieved by counting the number of occurrences of operation within the Pareto front solution set, this number will be averaged by the maximum number of occurrences found.

TABLE 6
Three simplified refactoring solutions recommended for JVacation v1.0.

| | | |
|---|---|---|
| Operation | Source entity | Target entity |

Solution 1 fitness scores before normalization (0.198, 4)

| | | |
|---|---|---|
| Move Method | ctrl.booking.BookingController::handleLodgingViewEvent(java.awt.event.ActionEvent):void | ctrl.booking.LodgingModel |
| Extract Class | ctrl.booking.SelectionModel:: −flightList + addFlight( ):void + clearFlight( ):void | ctrl.booking.FlightList |
| Move Method | ctrl.booking.BookingController::createBookings( ):void | ctrl.CoreModel |
| Move Method | gui.panels.booking.bTravelersPanel::getSalutation( ):java.lang. String | gui.components.LabelSpinner |

| | |
|---|---|
| Solution 1 Rank | 3.960 |

Solution 2 fitness scores before normalization (0.202, 5)

| | | |
|---|---|---|
| Move Method | ctrl.booking.BookingController::handleLodgingViewEvent(java.awt.event.ActionEvent):void | ctrl.booking.lodgingList |
| Move Method | gui.panels.maintenance.mLodgingsPanel::getStart( ):java.util.Date | gui.components.LabelCombo |
| Inline Class | ctrl.ModelChangeEvent | ctrl.CoreModel |
| Extract Class | ctrl.booking.SelectionModel:: −travelerList + addTraveler( ):void + clearTraveler( ):void | ctrl.booking.TravelerList |
| Move Method | gui.panels.booking.bTravelersPanel::getSalutation( ):java.lang.String | gui.components.LabelSpinner |

| | |
|---|---|
| Solution 2 Rank | 4.064 |

Solution 3 fitness scores before normalization (0.209, 6)

| | | |
|---|---|---|
| Move Method | ctrl.booking.BookingController::handleLodgingViewEvent(java.awt.event.ActionEvent):void | ctrl.booking.lodgingList |
| Move Method | gui.panels.maintenance.mLodgingsPanel::getStart( ):java.util.Date | gui.components.DateEdit |
| Extract Class | ctrl.booking.SelectionModel:: −flightList + addFlight( ):void + clearFIight( ):void | ctrl.booking.FlightList |
| Extract Class | ctrl.booking.SelectionModel:: −travelerList + addTraveler( ):void + clearTraveler( ):void | ctrl.booking.TravelerList |
| Inline Class | ctrl.ModelChangeEvent | ctrl.CoreModel |
| Move Class | Db.factory.DBObjectFactory | db |

| | |
|---|---|
| Solution 3 Rank | 3.471 |

In the interaction part, the recommended refactoring wanted to move a function that defines the trip's starting date to a LabelCombo class. The developer thought that moving it to DateEdit class makes more sense instead because the return value of the moved function is of type Date and DateEdit is semantically closer to the method. So the refactorings were partially modified by the developer and the ranking score of the second solution was increased by 0.5 for Solution 2 but by 1 for Solution 3 since it has already a move method operation that suggests moving the same method to the chosen class by the developer, i. e., the applied operation exists in that solution.

In the third interaction, the recommended refactoring suggests merging two classes CoreModel and ModelChangeEvent. The first class gathers, for a given customer, all his/her bookings and sums up the total price, since the price may be later on reduced based on the customer's premium number (field to be added) the developer decided to keep the class intact and thus the operation was rejected and so the score of the top Solution 2 was decreased by 1. The solution with the highest rank is selected for execution and its related operations are shown to the user based on their order in the vector. Table 7 summarizes the various interactions between the developer and the suggested refactorings from the three above mentioned solutions when adding the new feature.

TABLE 7
Four different interaction examples with the developer applied
on the refactoring solutions recommended for JVacation v1.0.

| Operation | R1:MoveMethod(ctrl.booking.BookingController | | | | |
|---|---|---|---|---|---|
| | ::handleLodgingViewEvent;void, | | | | |
| | ctrl.booking.LodgingList) | | | | |
| Decision | Applied | | | | |
| Changes | AppliedRefactoringsList = {R1} | | | | |
| | RejectedRefactoringsList = { } | | | | |
| SolutionSet | Solution1 | Solution2* | | Solution3 | |
| Initial rank | 3.960 | 4.064 | | 3.471 | |
| Interation1 | 3.960 | 5.064 | (+1) | 4.471 | (+1) |
| Operation | R2:MoveMethod(gui.panels.maintenance. | | | | |
| | mLodgingsPanel::getStart( ):java.util.Date, | | | | |
| | guicomponents.LabelCombo) | | | | |
| Decision | Modified to: R2: | | | | |
| | MoveMethod(gui.panels.maintenance. | | | | |
| | mLodgingsPanel::getStart( ):java.util.Date, | | | | |
| | guicomponents.DateEdit) | | | | |
| Changes | AppliedRefactoringsList = {R1, R2}, | | | | |
| | RejectedRefactoringsList = { } | | | | |
| SolutionSet | Solution1 | Solution 2* | | Solution3 | |
| Initial rank | 3.960 | 4.064 | | 3.471 | |
| Interation1 | 3.960 | 5.064 | (+1) | 4.471 | (+1) |
| Interation2 | 3.960 | 5.564 | (+0.5) | 5.471 | (+1) |
| Operation | R3: InlineClass(ctrl.ModelChangeEvent, ctrlCoreModel) | | | | |
| Decision | Rejected | | | | |
| Changes | AppliedRefactoringsList = {R1. R2} | | | | |
| | RejectedRefactoringsList = {R3} | | | | |
| Solution Set | Solution1 | Solution2 * | | Solution3 | |
| Initial rank | 3.960 | 4.064 | | 3.471 | |
| Interation1 | 3.960 | 5.064 | (+1) | 4.471 | (+1) |
| Iteration2 | 3.960 | 5.564 | (+0.5) | 5.471 | (+1) |
| Iteration3 | 3.960 | 4.564 | (−1) | 5.471 | |
| Operation | R4: ExtractClass(ctrl.booking.SelectionModel:: | | | | |
| | flightList + addFlight( ):void + clearFlight( ):void, | | | | |
| | ctrl.booking.FlightList) | | | | |
| Decision | Applied | | | | |
| Changes | AppliedRefactoringsList = {R1mR2, R4}, | | | | |
| | RejectedRefactoringsList = {R3} | | | | |
| SolutionSet | Solution1 | Solution2 | | Solution3 * | |
| Initial rank | 3.960 | 4.064 | | 3.471 | |
| Iteration1 | 3.960 | 5.064 | (+1) | 4.471 | (+1) |
| Iteration2 | 3.960 | 5.564 | (+1) | 5.471 | (+1) |

| | | | | |
|---|---|---|---|---|
| Iteration3 | 3.960 | 4.564 | (−1) | 5.471 |

| | | | | | |
|---|---|---|---|---|---|
| Iteration4 | 4.960 | (+1) | 4.564 | 6.471 | (+1) |

The first recommended refactoring of the top ranked solution (Solution 2) suggests moving an event function from the controller class of the booking process, since the developer is required to investigate this class and since this function is not called during the booking procedure, moving it out of the class will reduce the number of investigated functions, so the operation was applied by the developer and accordingly the ranking score was increased by 1 for both Solutions 2 and 3 since they include this refactoring in their solutions.

Upon the rejection of the third suggested refactoring, the ranking score of solution 3 has become higher than the one of solution 2, this has triggered the fourth recommended operation to be issued from solution 3 instead. All the refactorings that belong to the intersection between solution 3 and the lists of applied/rejected refactorings will be skipped during the recommendation process.

For instance, the first and second operation of solution 3 will be skipped as they have been already applied by the developer, and the third operation will be suggested during the fourth interaction. This operation suggests the extraction of a class from the selection mode of the booking process. Since this refactoring will facilitate the distinction between functions related to the flight from those related to the passengers, the developer has approved the operation. The algorithm will stop recommending new refactorings either on the request of the developer or when the system achieves acceptable quality improvement in terms of reducing the number of design defects and improving quality metrics. These parameters can be specified by the developer or the team manager.

To evaluate the ability of the refactoring framework to generate good refactoring recommendations, a set of experiments were conducted based on eight open source systems and two industrial projects. The obtained results are subsequently statistically analyzed with the aim of comparing the proposal with a variety of existing approaches. The relevant data related to our experiments and a demo about the main features of the tool can be found in http://kessentini.net/tse18. The research questions and validation methodology were presented followed by experimental setup. Then the obtained results were described and discussed.

Three categories of research questions were defined to measure the correctness, relevance and benefits of the interactive multi-objective refactoring approach comparing to the state of the art based on several practical scenarios. It is important to evaluate, first, the correctness of the recommended refactoring. Since it is not sufficient to make correct refactoring recommendations, the benefits of applying the recommended refactorings in terms of fixing code smells and improving quality attributes were evaluated. Programmers are not interested, in practice, to apply all the correct and useful recommended refactorings due to limited resources thus both the relevance of our recommendations and the ranking efficiency from programmers perspective based on several real-world scenarios including productivity and post-study questionnaires were evaluated. Various existing refactoring approaches were considered as a baseline for this proposed interactive refactoring technology to define an accurate estimation of possible improvements.

The research questions are as follows:
RQ1: Correctness, Relevance and Comparison with State of The Art.
   RQ1-a: Correctness. To what extent the results of our approach are similar to the ones proposed by developers compared to fully-automated refactoring techniques?
   RQ1-b: Benefits-antipatterns correction. To what extent code smells can be fixed using our approach compared to fully-automated refactoring techniques?
   RQ1-c: Benefits-improving quality. To what extent can our approach improve the overall quality of software systems compared to fully-automated refactoring techniques?
   RQ1-d: Relevance to programmers. To what extent can our approach make meaningful recommendations compared to fully-automated refactoring techniques?
RQ2: Interaction Relevance. To what extent can our approach efficiently rank the recommended refactorings:
RQ3: Impact based on Practical Scenarios.
   RQ3-a: To what extent our approach can improve the productivity of programmers when fixing bugs compared to fully-automated refactoring techniques?
   RQ3-b: To what extent our approach can improve the productivity of programmers when adding new features compared to fully-automated refactoring techniques?

To answer the research questions described above, an overview about the adopted validation methodology that include the following tasks are given:
Task 1: Generate date for baseline methods by using other existing state-of-the-art automated refactoring tools and methods offline. (RQ1a-d)
Task-2: Manually refactor a system. (RQ1a).
Task-3:Use the tool (DINAR) to collect final set of recommendations (RQ1a-d, RQ2).
Task-4: Rate solutions and recommendations of different methods and tools. (RQ1d, RQ2)
Task-5: Code smells detection after refactoring. (RQ1b)
Task 6: Measure quality metrics after refactoring. (RQ1c)
Task 7: Fix bugs on refactored/unrefactored systems. (RQ3a)
Task 8: Implement features on refactored/unrefactored systems. (RQ3b)
Task 9: Post-study questionnaire. (RQ3c)

For each task, different evaluation metrics (Precision, Recall, number of fixed antipatterns, the quality gain, manual correctness, number of modified/rejected/accepted recommendations and execution time) which are described in this section are defined and used. These metrics are calculated and compared for different refactoring techniques which are applied on a variety of software projects under the specific above scenarios. Table 8 shows the summary of the connections between the research questions, metrics and tasks detailed in this section.

TABLE 8
Summary of the research questions, their goals, defined metrics to answer and analyze
them, and the associated tasks to collect data and calculate the metrics.

| RQ# | RQ Goal | Sub-RQ | Sub-Goal | Metric(s) | Task(s)# |
|---|---|---|---|---|---|
| RQ1 | Relevant | RQ1-a | Similarity | RC, PR | 1, 2, 3 |
| | Solutions | | | | |
| | | RQ1-b | Fixing code smells | NF | 1, 3, 5 |
| | | RQ1-C | Overall quality | G | 1, 3, 6 |
| | | RQ1-d | Meaningful recommendation | MC | 1, 3, 4 |
| RQ2 | Efficient ranking | — | | NAR, NRR, NMR, | 3, 4 |
| | | | | PR@k, MC@k | |
| RQ3 | Usefulness | RQ-3a | Productivity/fixing bugs | TP | 7 |
| | | RQ3-b | Productivity/adding features | | 8 |
| | | RQ3-C | questionnaire | | 9 |

In order to have a consistent comparison, the refactoring solutions recommended by the approach after all interactions with the developers (last set of solutions) is considered. Therefore, these sets of refactoring solutions are referred to as the approach results afterward. To create a baseline, the participants in the study are asked to analyze and apply manually several refactoring types using Eclipse IDE on several code fragments extracted from different systems where most of them correspond to code smells identified in previous studies as worth removing by refactoring. This golden set is defined based on the following two main criteria: 1) refactorings that fix a design flaw and did not change the behavior or introduce bugs, and 2) refactorings that improve a set of quality metrics (based on the QMOOD model) and did not change the behavior or introduce bugs. These refactoring solutions are referred to as expected refactorings afterward.

To answer RQ1, it is important to validate the proposed refactoring solutions from both quantitative and qualitative perspectives. For RQ1-a, precision and recall scores are calculated to compare between refactorings recommended by each approach and those expected based on the participants opinion:

$$\begin{matrix}{RC}_{recall} = \frac{Approach Solution ⋂ Expected Refactorings}{Expected Refactorings} ∈ [ 0 , 1 ] & ( 5 ) \\ {PR}_{precision} = \frac{Approach Solution ⋂ Expected Refactorings}{Approach Solution} ∈ [ 0 , 1 ] & ( 6 )\end{matrix}$$

When calculating the precision and recall, a refactoring is considered as a correct recommendation if all the controlling parameters are the same like the expected ones. For RQ1-b, another quantitative evaluation is considered which is the percentage of fixed code smells (NF) by the refactoring solution. The detection of code smells after applying a refactoring solution is performed using the detection rules described by M. Kessentini et al of Design Defects Detection and Correction by Example“, IEEE 19th International Conference on Program Comprehension (ICPC)' (2011. 2011). Formally, NF is defined as:

$$NF = \frac{\# fixed code smells}{\# code smells} ∈ [ 0 , 1 ] \qquad ( 7 )$$

The detection of code smells is very subjective and some developers prefer not to fix some smells because the code is stable or some of them are not important to fix. To this end, we considered for RQ1-c another metric, G, based on QMOOD that estimates the quality improvement of the system by comparing the quality before and after refactoring independently from the number of fixed design defects. The average of the six QMOOD attributes were used: reusability, flexibility, understandability, Extendability, Functionality and effectiveness. All of them are formalized using a set of quality metrics. Hence, the gain for each of the considered QMOOD quality attributes and the average total gain in quality after refactoring can be easily estimated as:

$$G = \frac{{\sum }_{i = 1}^{6} {G}_{qi}}{6} and {G}_{qi} = {q}_{i}^{′} - {q}_{i} \qquad ( 8 )$$

where q′ᵢ and qᵢ represents the value of the QMOOD quality attribute i after and before refactoring, respectively. For RQ1-d, the participant is asked in the study to evaluate, manually, whether the suggested refactorings are feasible and efficient at improving the software quality and achieving their maintainability objectives. The metric Manual Correctness (MC) is defined to mean the number of meaningful refactorings divided by the total number of recommended refactorings. The meaningful refactorings are recognized by taking the majority of votes from the developers. This procedure is analogous to the real-world situations based on our the experience with industrial partners. Therefore, MC is given by the following equation

$$MC = \frac{\# Meaningful Refactorings}{\# Recommended Refactorings} \qquad ( 9 )$$

To avoid the computation of the MC metric being biased by the developer's feedback, the developers are asked to manually evaluate the correctness of the recommended refactorings of the approach on the systems that they did not refactor using the tool. Therefore, the developers did not evaluate the results of their own results of interactive refactoring but the resultant refactorings recommended on other systems where other developers applied the approach. The main motivation for the manual correctness metric is evaluated manually on each refactoring one-by-one to check their validity. Thus, the results produced by the different tools were evaluated were not limited to the comparison with the expected results. The comparison with the expected results to provide an automated way to evaluate the results and avoid the developers being biased by the results of the tool (developers did not know anything about the refactorings suggested by the different tools when they provided their recommendations).

The metrics MC, RC, PR, NF and G are used to perform the comparisons and answer respectively RQ1a-d. Some other useful metrics were considered to answer RQ2 that count the percentage of refactorings that were accepted (NAR) or rejected (NRR) or applied with some modifications (NMR). Formally, these metrics are defined as:

$$\begin{matrix}NAR = \frac{\# Accepted Refactorings}{\# Recommended Refactorings} ∈ [ 0 , 1 ] & ( 10 ) \\ NRR = \frac{\# Rejected Refactorings}{\# Recommended Refactorings} ∈ [ 0 , 1 ] & ( 11 ) \\ NMR = \frac{\# Modified Refactorings}{\# Recommended Refactorings} ∈ [ 0 , 1 ] & ( 12 )\end{matrix}$$

To answer RQ2, the relevance of the recommended refactorings were evaluated in the top k where k=1, 5,10 and 15 using the following metrics PR@k and MC@k. The same equations defined for RQ1 with the only difference that the considered suggested refactorings are exclusively those located in the top k positions of the ranked list of refactorings at multiple instances after the execution of the innovization component.

To answer RQ3, the aim to assess how the refactoring actually increases the software quality and productivity in that the effort to fixing bugs (R3-a) or adding new features (R3-b) should reduce after performing the refactorings. The software developers were asked to participated in the study to add new features and fix a set of bugs. To avoid that the achieved results might be due to the different levels of ability of the developers groups, a counter-balanced design was adapted where each participant performed two tasks, one on the original system and one on the refactored system. The details of these scenarios will be described later. To estimate the impact of the suggested refactorings on the productivity of developers, the following metric TP was defined to measure the time required to perform the same activities on the system with and without refactoring:

$${TP}_{i} = \frac{\begin{matrix}\# minutes required to perform \\ task i on the system after refactoring\end{matrix}}{\begin{matrix}minutes required to perform task i \\ on the system before refactoring\end{matrix}} \qquad ( 13 )$$

The productivity results were compared to other approaches to test the hypothesis if better quality of the software may increase the productivity of developers. To answer RQ3-b, a post-study questionnaire was used that collects the opinions of developers on the tool as detailed below.

A set of well-known open-source Java projects and two systems from industrial partner were used. The approach was applied to eight open-source Java projects: Xerces-J, JHotDraw, JFreeChart, GanttProject, Apache Ant, Rhino and Log4J and Nutch. Xerces-J is a family of software packages for parsing XML. JFreeChart is a free tool for generating charts. Apache Ant is a build tool and library specifically conceived for Java applications. Rhino is a JavaScript interpreter and compiler written in Java and developed for the Mozilla/Firefox browser. GanttProject is a cross-platform tool for project scheduling. Log4J is a popular logging pack- age for Java. Nutch is an Apache project for web crawling. JHotDraw is a GUI framework for drawing editors.

In order to get feedback from the original developers of a system, experiments in two large industrial projects provided by our industrial partner were considered. The first project is a marketing return on investment tool, called MROI, used to predict the sales of cars based on the demand, dealers information, advertisements, etc. The tool can collect, analyze and synthesize a variety of data types and sources related to customers and dealers. It was implemented over a period of more than eight years and frequently changed to include and remove new/redundant features.

The second project is a Java-based software system, JDI, which helps the company to create the best schedule of orders from the dealers based on thousands of business constraints. This system is also used by the company to improve their vehicles sales by selecting the right vehicle configuration to match the expectations of their customers. JDI is highly structured and software developers have developed several versions of it over the past 10 years. Due to the importance of the application and the high number of updates performed on both systems, it is critical to ensure that they remain of high quality so to reduce the time required by developers to introduce new features in the future.

These 10 systems were selected for our validation because they range from medium to large-sized open-source projects, which have been actively developed over the past 10 years, and their design has not been responsible for a slowdown of their developments. Table 9 provides some descriptive statistics about these 10 programs.

TABLE 9
Statistics of the studied software projects

| | | | | #Code | #Applicable |
|---|---|---|---|---|---|
| System | Release | #classes | KLOC | smells | Refactorings |
| Xerces-J | v2.7.0 | 991 | 240 | 61 | 80 |
| JHotDraw | v6.1 | 585 | 21 | 22 | 36 |
| JFreeChart | v1.0.9 | 521 | 170 | 51 | 96 |
| GanttProject | v1.10.2 | 245 | 41 | 60 | 63 |
| Apache Ant | v1.8.2 | 1191 | 255 | 61 | 74 |
| Rhino | v1.7R1 | 305 | 42 | 79 | 50 |
| Log4J | v1.2.1 | 189 | 31 | 27 | 41 |
| Nutch | v1.1 | 207 | 39 | 39 | 24 |
| JDI | v5.8 | 638 | 247 | 83 | 94 |
| MROI | V6.4 | 786 | 264 | 97 | 119 |

The study involved 14 participants from the University of Michigan and 8 software developers. Participants include 6 master students in Software Engineering, 8 Ph.D. students in Software Engineering and 8 software developers. All the participants are volunteers and familiar with Java development and refactoring. The experience of these participants on Java programming ranged from 2 to 19 years. The participants were carefully selected to make sure that they already applied refactorings during their previous experiences in development.

All the graduate students have already taken at least one position as software engineer in industry for at least two years as software developer and most of them (11 out of 14 students) participated in similar experiments in the past, either as part of a research project or during graduate courses on Software Quality Assurance or Software Evolution offered at the University of Michigan. Furthermore, 6 out the 14 students (the selected master students) are working as full-time or part-time developers in the software industry.

Participants were first asked to fill out a pre-study questionnaire containing five questions. The questionnaire helped to collect background information such as their role within the company, their programming experience, and their familiarity with software refactoring. In addition, all the participants attended one lecture about software refactoring and passed six tests to evaluate their performance in evaluate and suggest refactoring solutions.

Three groups were formed. The groups were formed based on the pre-study questionnaire and the test results to ensure that all the groups have almost the same average skill level. The participants were divided into groups according to the studied systems, the techniques to be tested and developers' experience.

Each of the first two groups (A and B) is composed of three masters students and four Ph.D. students. The third group is composed of eight software developers, since they agreed to participate only in the evaluation of their two software systems. It is important to note that the third group formed by the developers is part of the original developers of the two evaluated systems.

To answer research questions from the perspective of evaluating the interactive approach performance against the state-of-the-art refactoring techniques, the approach was compared to four other existing fully-automated search-based refactoring techniques and the multi-objective approach without the interaction component (NSGA-II-Innovization). Studied techniques include: Kessentini which is described by Kessentin et. al. in “Design Defects Detection and Correction by Example” IEEE 19th International Conference on Program Comprehension” (ICPC) (2011); O'Keeffe which is described by O'Keefee et. al. in “Search-based refactoring for software maintenance” Journal of Systems and Software 81(4): 502-516. (2008); Ouni which is described by Ouni et al. in “Multi-criteria Code Refactoring Using Search-Based Software Engineering: An Industrial Case Study”, ACM Transactions on Software Engineering and Methodology (TOSEM), 2016; and Harman which is described by Harman et al. in “Pareto optimal search based refactoring at the design level” Proceedings of the 9th annual conference on Genetic and evolutionary computation. London, England, ACM: 1106-1113. (2007).

Experiments considered another popular design defects detection and correction tool, JDeodorant, that does not use heuristic search techniques. Further information about the JDeodorant tool can be found in “JDeodorant: identification and application of extract class refactorings” 33^{rd} international Conference on Software Engineerying (2011). The current version of JDeodorant is implemented as an Eclipse plug-in that identifies some types of design defects using quality metrics and then proposes a list of refactoring strategies to fix them. Since JDeodorant just recommends a few types of refactoring with respect to the ones considered by the tool. In this case, the comparison is restricted to the same refactoring types supported by JDeodorant such as Move Method, Extract Method and Extract Class.

The approach differs with the above fully-automated techniques in two factors: innovization and interactive features. Therefore, it is important to evaluate the impact of every factor on the quality of the results. If the innovization makes the largest contribution, which is another fully automated search-based approach, the results cannot support the hypothesis related to the outperformance of interactive refactoring. Thus, the approach to NSGA-Il is compared with the innovization feature using the same mufti-objective optimization but without the use of the interactive feature.

All these existing techniques are fully-automated and do not provide any interaction with the developers to update their solutions.

Table 10 summarizes the survey organizations including the list of systems and algorithms evaluated by the groups of participants.

TABLE 10
Survey organization.

| Participants | Software | | |
|---|---|---|---|
| groups | Projects | Approaches | Tasks |
| Group A | Xerces-J | Interactive | Interactive |
| | JHotDraw | NSGA-II, | refactoring |
| | JFreeChart | O'Keeffe, | Manual refactoring |
| | GanttProject | Ouni | Post-study |
| Group B | Apache Ant | JDeodorant, | questionnaire |
| | Rhino | Kessentini, | Fixing bugs |
| | Log4J | Harman | Adding features |
| | Nutch | | |
| Group C | JDI | Interactive | |
| | MROI | NSGA-II, | |
| | | O'Keeff, | |
| | | Ouni, | |
| | | JDeodorant | |

Parameter setting influences significantly the performance of a search algorithm on a particular problem. For this reason, for each algorithm and for each system, a set of experiments is performed using several population sizes: 50, 100, 200, 300 and 500. The stopping criterion was set to 100,000 evaluations for all algorithms in order to ensure fairness of comparison. The other parameters' values were fixed by trial and error and are as follows: crossover probability=0.8; mutation probability=0.5 where the probability of gene modification is 0.3; stopping criterion=100,000 evaluations. In order to have significant results, for each couple (algorithm, system), the trial and error method is used in order to obtain a good parameter configuration. Trial and error is a fundamental method of problem solving. It is characterized by repeated and varied attempts of algorithm configurations.

Regarding the evaluation of fixed code smells, the following code smell types were focused on: Blob, Spaghetti Code (SC), Functional Decomposition (FD), Feature Envy (FE), Data Class (DC), Lazy Class (LC), and Shotgun Surgery (SS). These code smell types were chosen in the experiments because they are the most frequent and hard to fix based on several studies. These design flaws are automatically detected using the detection rules of previous work based on genetic programming. A set of metrics-based rules that can automatically detect the different types of code smells considered in our experiments have been generated and manually validated.. Table 6 reports the number of code smells for each system. Only real design flaws that were manually validated are considered in this validation.

The upper and lower bounds on the chromosome length used in this study are set to 10 and 350, respectively. Several SBSE problems including software refactoring are characterized by a varying chromosome length. This issue is similar to the problem of bloat control in genetic programming where the goal is to identify the tree size limits. To solve this problem, several trial and error experiments were performed where the average performance of the algorithm using the hypervolume (HV) performance indicator while varying the size limits between 10 and 500 operations was assessed.

Each group of participants received a questionnaire, a manuscript guide to help them to fill the questionnaire, the tools and results to evaluate and the source code of the studied systems as described in the following five scenarios:

In the first scenario, a total of 90 classes were selected from all the systems that include design defects (9 classes to fix per system). Then every participant was asked to manually apply refactorings to improve the quality of the systems by fixing an average of two of these defects. As an outcome of this scenario is a set of expected refactorings which are able to calculate the differences between the recommended refactorings and the expected ones (manually suggested by the developers).

In the second scenario, the developers were asked to evaluate the suggested solutions of the algorithm. A cross-validation was performed between the ratings of each group to avoid the computation of the MC metric being biased by the developer's feedback. Thus, the developers in each group rated results generated by the other developers in the same group.

In the third scenario, a set of 6 bugs per system were collected from the bug reports of the studied release for every project and asked the groups to fix them based on the refactored and non-refactored version. The tasks are completely different and they are applied to different packages/classes of the same version of the systems. Furthermore, the participants did not know if they are working on the system before or after refactoring. No specific order was followed when asking the developers to work on the tasks. Only 3 out of the 22 participants worked as part of the experiments on the systems before refactoring and then the systems after refactoring. A counter-balanced design was adapted where every developer to fix 2 bugs on the version before refactoring and then 2 other bugs in the version after refactoring. The bugs that require almost the same effort to fix in terms of number of changes, with an average of 15 changes were selected.

In the fourth scenario, the groups were asked to add two simple features to every system before refactoring, and then two other features on the system after refactoring. All the features require almost the same number of changes to be introduced or deleted with an average of 23 code changes per feature. In the third and fourth scenarios, the bugs to fix and features to add are related to the classes that are refactored by the developers when using the tool.

The participants were asked to justify their evaluation of the solutions and these justifications are reviewed by the organizers of the study (one faculty member, one postdoc, one Ph.D. student and one Master's student). Participants do not know the particular experiment research questions and the used algorithms.

In the fifth scenario, the participants were asked to use the tool during a period of two hours on the different systems and then collected their opinions based on a post-study questionnaire. To better understand subjects' opinions with regard to usefulness of the approach in a real setting, the post-study questionnaire was given to each participant after completing the refactoring tasks using the interactive approach and all the techniques considered in our experiments. The questionnaires collected the opinions of the participants about their experience in using the approach compared to manual and fully-automated refactoring tools. Participants were asked to rate their agreement on a Likert scale from 1 (complete disagreement) to 5 (complete agreement) with the following statements:
1) The interactive dynamic refactoring recommendations are a desirable feature in integrated develop ment environments (IDEs).
2) The interactive manner of recommending refactorings by our approach is a useful and flexible way to refactor systems compared to fully-automated or manual refactorings.
   The remaining questions of the post-study questionnaire were about the benefits and also limitations (possible improvements) of the interactive approach.

Since meta-heuristic algorithms are stochastic optimizers, they can provide different results for the same problem instance from one run to another. For this reason, the experimental study is based on 30 independent simulation runs for each problem instance. The following statistical tests show that all the comparisons performed between our approach and existing ones are statistically significant based on all the metrics and the systems considered in the experiments.

One-way ANOVA statistical test were used with a 95% confidence level (α=5%) to find out whether the sample results of different approaches are different significantly. Since one-way ANOVA is an omnibus test, a statistically significant result determines whether three or more group means differ in some undisclosed way in the population. One-way ANOVA is conducted for the results obtained from each software project to investigate and compare each performance metric (dependent variable) between various studied algorithems (independent variable-groups) The null hypothesis (H₀) that population means of each metric are equal for all methods ((∀Software Projects: μ_{M1}^{metric}=μ_{M2}^{metric}=. . . =μ_{M7}^{metric} where metric ∈ {G, NF, MC, PR, RC}) against the alternative (H₁) that they are not equal and at least one method population mean is different.

There are some assumptions for one-way ANOVA test which are assessed before applying the test on the data. Outliers: There were no outliers in the data, as assessed by inspection of a boxplot for values greater than 1.5 box-lengths from the edge of the box. Normal Distribution: Some of the dependent variables were not normally distributed for each method, as assessed by Shapiro-Wilk's test. However, the one-way ANOVA is fairly robust to deviation from normality. Since the sample size is more than 15 (there are 30 observations in each group) and the sample sizes are equal for all groups (balanced), non-normality is not an issue and does not affect Type I error. Homogeneity of variances: The one-way ANOVA assumes that the population variances of the dependent variables are equal for all groups of the independent variable. If the variances are unequal, this can affect the Type I error rate. There was homogeneity of variances, as assessed by Levene's test for equality of variances (p>0.05).

The results of one-way ANOVA tests for all pair of software projects and metrics indicates that the group means were statistically significantly different (p>0.05) and, therefore, one can reject the null hypothesis and accept the alternative hypothesis which says there is difference in population means between at least two groups. Table 11 reports the obtained value of F-statistics with the between and within groups degree of freedoms equal to 6 and 203, respectively. In one-way ANOVA, the F-statistic is the ratio of variation between sample means over variation within the samples. The larger value of F-statistics represents the group means are further apart from each other and are significantly different. Also, it shows that the observation within each group are close to the group mean with a low variance within samples. Therefore, a large F-value is required to reject the null hypothesis that the group means are equal. The obtained F-statistics results are correspond to very small p-values.

One-way ANOVA does not report the size of the difference. Therefore, one can calculatedEta squared (η²) which is a measure of the effect size (strength of association) and it estimates the degree of association between the independent factor and dependent variable for the sample. Eta squared is the proportion of the total variance that is attributed to a factor (the “refactoring methods” in this study). Table 12 reports Eta squared values for each pair of software projects and metrics. These values shows to what extent different algorithms are the cause of variability of the metrics. For instance, it says 90% of the total variance of metric G for ApacheAnt software project is accounted for by different algorithms effect, not error or other effects.

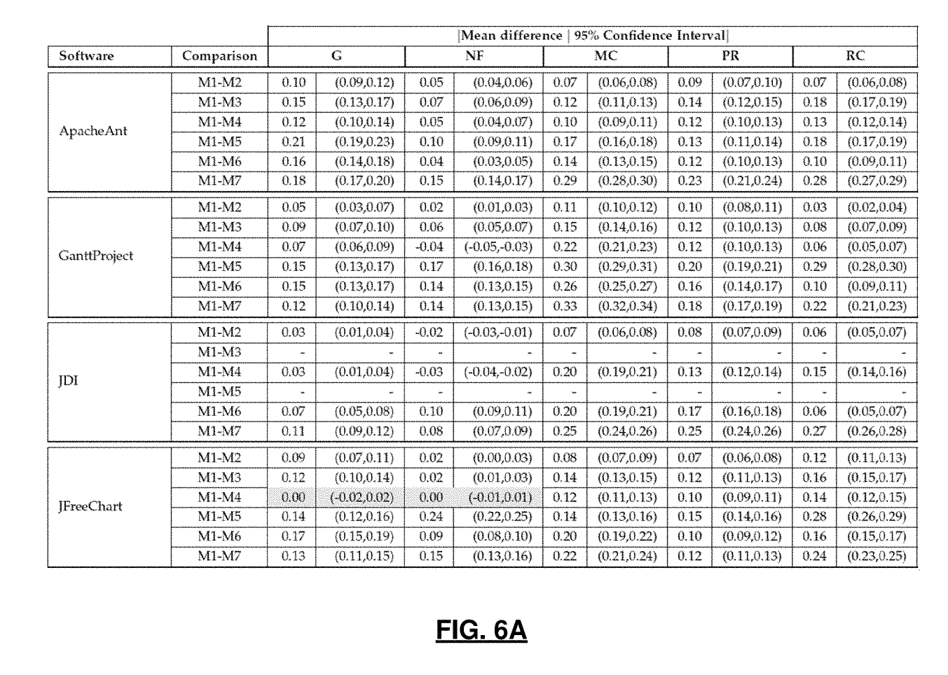

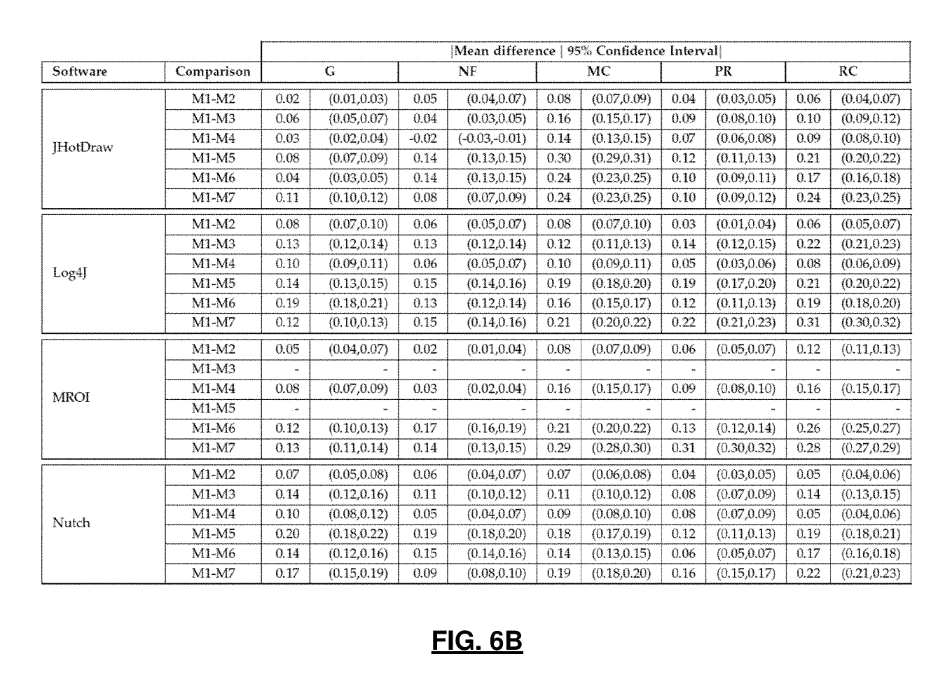

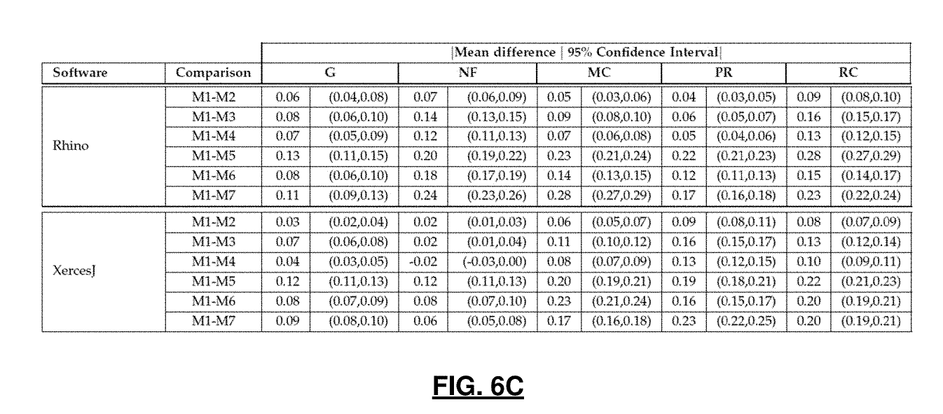

Tukey post hoc analysis is carried out in order to find out between which group(s) the significant difference is occurred. Basically, it tests all possible group comparisons. FIGS. 6A-6C present the results of comparison of the proposed interactive method to the others. This table represents the point estimate of the difference between each pair of means and is computed from the sample data, Also, it includes the confidence interval showing the difference between population means and is centered on point estimate. If this interval does not include zero, indicates that the difference between the means is statistically significant. The 95% individual confidence level indicates that one can be 95% confident that each interval contains the real difference for that particular comparison. The results shows that all pairwise comparisons between our method and others for each pair of (software/metric) are statistically significant at the 0.05 level except for G and NF of JFreeChart as their results highlighted in the table of the results. Therefore, the difference between the means of these two metrics,G and NF, for JFreeChart project is 0.

To this end, the Vargha-Delaney A was used to measure which is a non-parametric effect size measure. In this context, given the different performance metrics (such as PR, RC, MC, etc.), the A statistic measures the probability that running an algorithm B1 (interactive NSGA-II) yields better performance than running another algorithm B2. If the two algorithms are equivalent, then A=0.5. In the experiments, the following results were found: a) on small and medium scale software projects (GanttProject, Rhino, Log4J and Nutch) the approach is better than all the other algorithms based on all the performance metrics with an A effect size higher than 0.94; and b) on large scale software projects (JDI, MROI, Apache Ant, Xerces-J, JHotDraw and JFreeChart), the approach is better than all the other algorithms with an A effect size higher than 0.87.

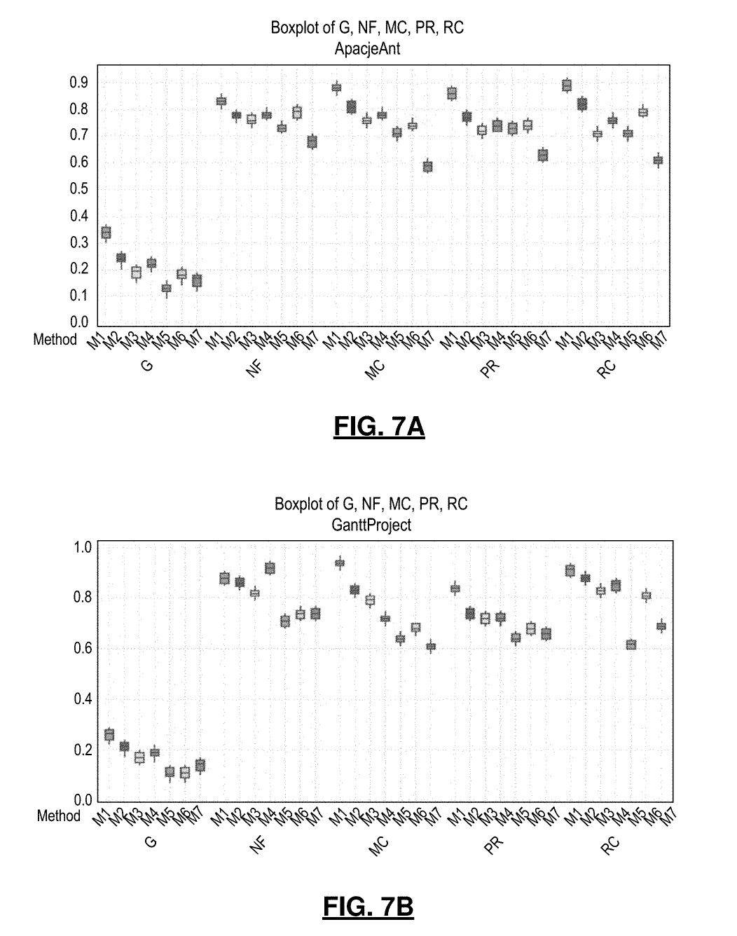

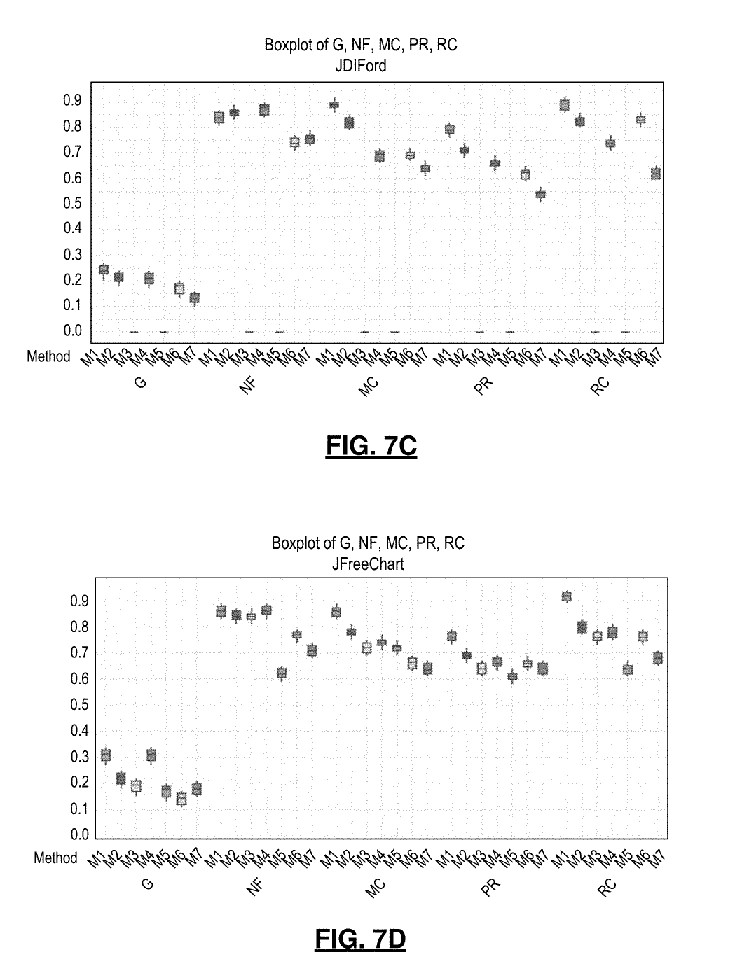

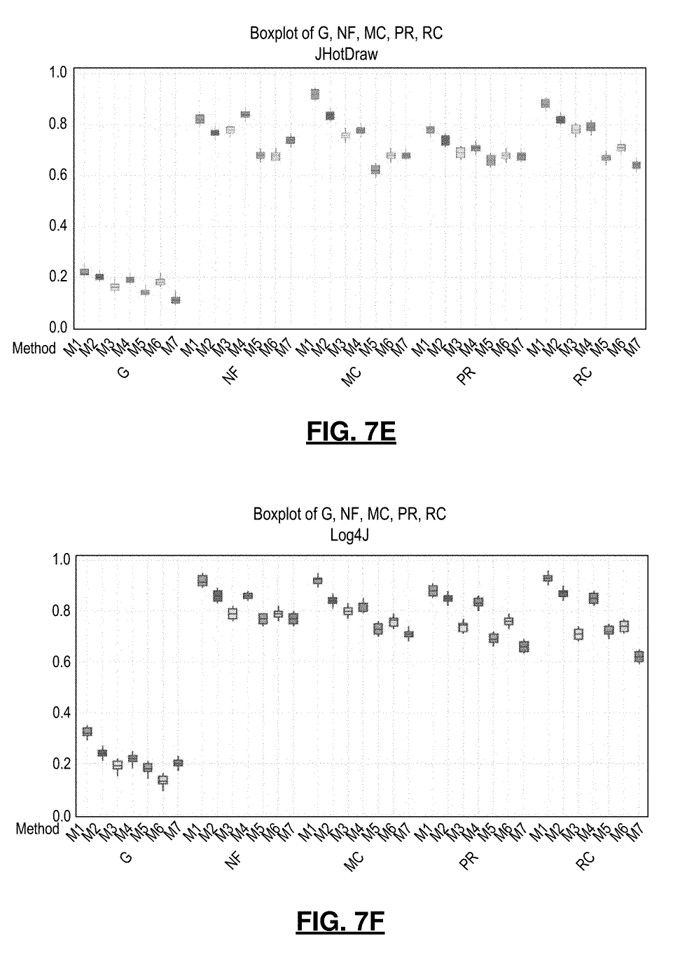

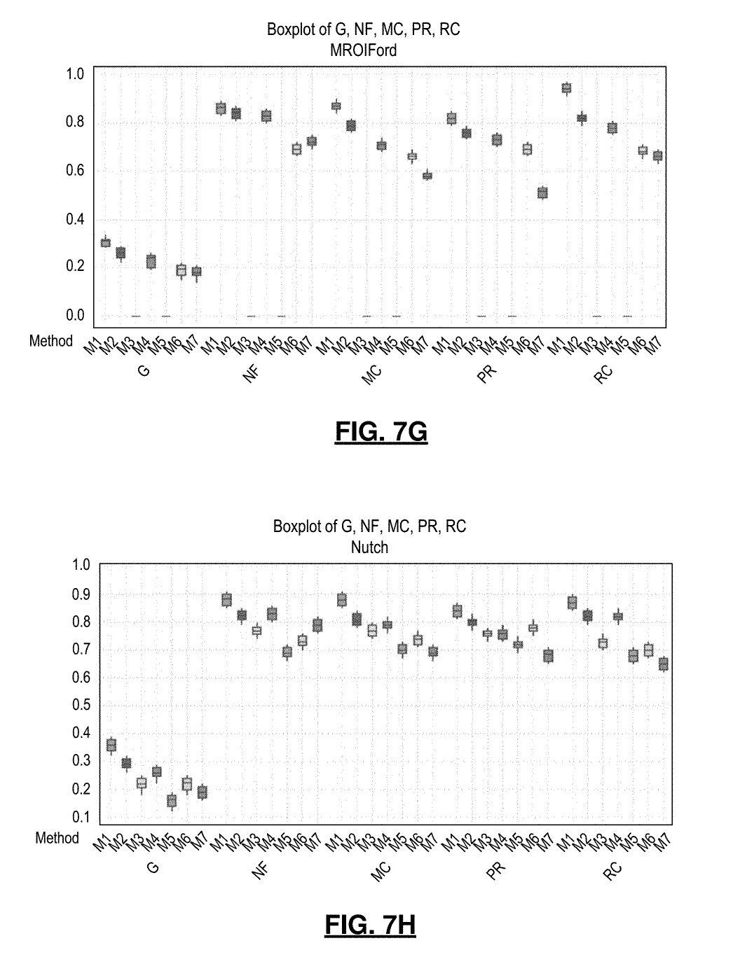

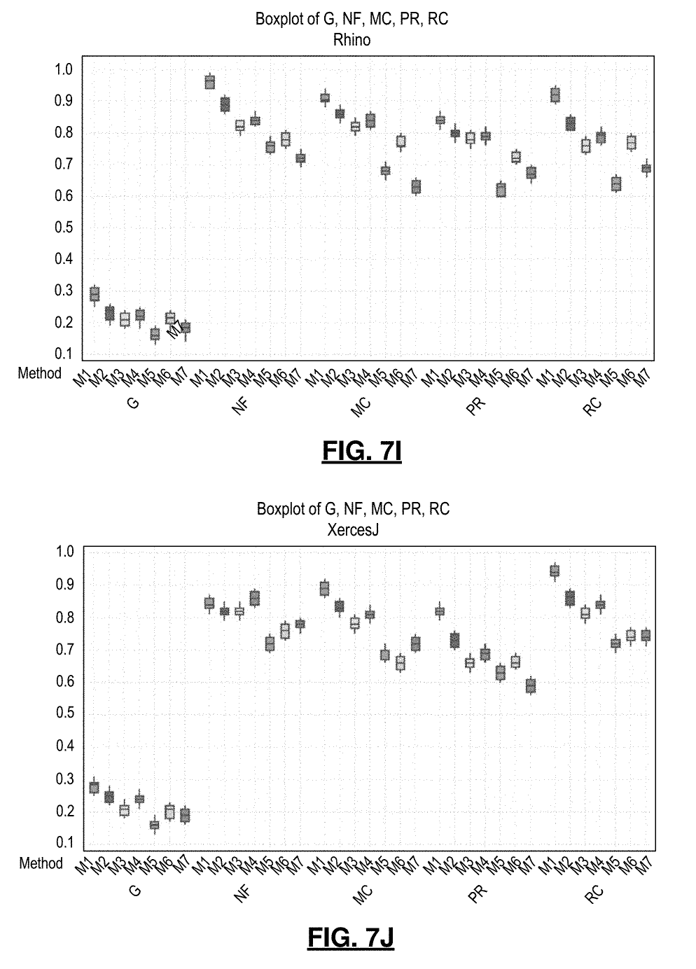

For the results for RQ1a, FIGS. 7A-7J summarizes the findings regarding the obtained precision (PR) and recall (RC) results on the 10 systems. A considerable number of proposed refactorings were found, with an average of more than 82% and 86% respectively in terms of precision and recall, were already applied by the software development team and suggested manually (expected refactorings). The recall scores are higher than precision ones since we found that the refactorings suggested manually by developers are incomplete compared to the solutions provided by our approach. In addition, the slight deviation with the expected refactorings found is not related to incorrect operations but to the fact that the developers were interested mainly in fixing the severest code smells or improving the quality of the code fragments that they frequently modify.

FIG. 7A-7J also confirms the out-performance of the interactive refactoring approach compared to existing fully-automated techniques and since a statistically significant difference between the means of metrics is confirmed, the better results are not obtained by chance. The precision and recall scores were consistent on all the ten systems which confirm that the results are independent from the size of the systems, number of refactorings and number of code smells. The closest results are those obtained by NSGA-II based on innovization (without interaction) and the multi-objective refactoring approach of Ouni et al. This may confirm that the obtained results are more due to the interaction component of our approach. A detailed qualitative discussion will be presented later in RQ1d.

For results for RQ1b, the ability of the approach was evaluated to fix several types of code smell. FIG. 7A-7J depict the percentage of fixed code smells (NF). It is higher than 82% on all the ten systems, which is an acceptable score since developers may reject or modify some refactorings that fix some code smells because they do not consider them very important (their goal is not to fix all code smells in the system) or the current version of the code becomes stable. Some systems, such as Rhino and Gantt, have a higher percentage of fixed code smells with an average of more than 88%. This can be explained by the fact that these systems include a higher number of code smells than others.

However, the percentage of fixed code smells (NF) is slightly lower than some fully-automated refactoring techniques. This is can be explained by the reason that the main goal of developers during the interaction process is not to fix the maximum number the code smells detected in the system (which was the goal) thus they rejected or modified some refactorings suggested by our tool. In addition, the approach is based on a multi-objective algorithm to find a trade-off between improving the quality and reducing the number of changes. Therefore, the slight loss in NF is explained by the fact that they are not considering fixing code smells as one of the objectives, and justified by a better improvement in the quality of the refactored system.

For results for RQ1c, FIGS. 6 and 7A-7J show that the refactorings recommended by the approach and applied by developers improved the quality metrics value (G) of the ten systems. For example, the average quality gain for the two industrial systems was the highest among the ten systems with more than 0.3. The improvements in the quality gain confirm that the recommended refactorings helped to optimize different quality metrics. The functionality attribute has the lowest improvement on the different systems. This may be explained by the fact that refactoring is expected to preserve the behavior of existing functionalities. The interactive approach clearly also outperforms existing fully-automated techniques. One of the reasons could be related to the fact that the optimization of the quality attributes is considered as part of the fitness functions unlike some of the existing techniques.

For results for RQ1d, the results of the empirical qualitative evaluation (MC) in FIGS. 7A-7J are reported. As reported in this figure, the majority of the refactoring solutions recommended by our interactive approach were correct and approved by developers. On average, for all of the ten studied projects, 87% of the proposed refactoring operations are considered as semantically feasible, improve the quality and are found to be useful by the software developers of the experiments. The highest MC score is 93% for the Gantt project and the lowest score is 86% for JFreeChart. Thus, it is clear that the results are independent of the size of the systems and the number of recommended refactorings. Most of the refactorings that were not manually approved by the developers were found to be either violating some post-conditions or introducing design incoherence.

FIGS. 7A-7J shows that the approach provides significantly higher manual correctness results (MC) than all other approaches having MC scores respectively between 60% and 78%, on average as MC scores on the different systems.

To provide more qualitative evaluation, some of the feedback was considered that was received from the developers since they are part of the original developers of these systems. For example, these developers rejected a set of move methods because they believed that these methods should stay in their original class. The original class in this case is responsible for implementing several security constraints (e.g. login information) around database access. The number of security constraints is very high and they were implemented in several methods grouped into one class. Although this set of methods created a blob, the developers assessed that they should stay together because there is a logic behind implementing them in that way, and splitting the behavior may require a redesign of the application.

In another case, the developers elected to extract a class that regroups several methods implementing a parser to extract dealer information. However, this refactoring was not recommended by our approach since the methods were located in a small class that did not contain any code smell or quality violation symptoms. Thus, the refactoring applied by the developers was more based on the features implemented in the methods. This refactoring is hard to recommend even with the considered semantics/textual similarity measures since few comments exist in these methods and furthermore their implementation structures look very different. These observations explain the reasons why some the refactorings recommended by our approach was rejected by the developers and also the differences with those that are manually recommended by the developers.

In general, it was found that most of the common patterns in the Pareto front are not individual operations, but a short sequence of refactorings. Thus, it is believed that most of these patterns are targeting specific quality issues and hence the applied refactorings are not individual operations but small refactoring patterns. This observation was found to be valid when manually checked the interactive results of the tool.

A general interesting observation from the experiments is that evolutionary search involves both diversification and convergence, so the question is does innovization emphasize convergence at the cost of sacrificing divergence? One would argue against this, for the following reasons. In the context of this refactoring problem, it is very rare to observe no overlap between non-dominated solutions for several reasons such as the large size of refactoring solutions and the fact that some common quality issues should be fixed (high priority). In fact, at least few quality issues (e.g. code smells) need to be fixed independently from the other objectives. Thus, it is normal to always observe some overlap between the refactoring solutions. Regarding diversification, the ranking of the refactoring solutions is only used after the generation of the Pareto front so this ranking is not part of the fitness function used in the search. The goal is to implicitly explore the front based on the feedback of the developers to identify the region of interest and prioritize the solutions that contain common patterns. It is believed that these common patterns distinguish non-dominated solutions from dominated ones. The diversification is not penalized because we do not consider the innovization heuristic as part of the fitness functions but as a post-processing step to prioritize solutions (and not eliminating them).

The results of the interactive approach (MI) and the innovization NSGA-II method (M2) were compared in FIGS. 6 and 7A-7jin order to contrast the impact of interactivity component. The best solution (at the knee point) based on the innovization feature (without interaction) was evaluated based on all studied metrics. The results confirm that the interactive approach outperforms NSGA-II with the only use of innovation (without interaction) in terms of G, NF, MC, PR, and RC. However, the results of NSGA-II with innovization are better than regular multi-objective refactoring approaches (e.g. Ouni et al., etc.) thus it is clear that the positive results of this approach are due to the combination of the two factors: innovization and interactive features.

The superior performance of this interactive approach can be explained by several factors. First, other approaches used only structural indications (quality metrics) to evaluate the refactoring solutions and thus a high number of refactorings lead to a semantically incoherent design. The interactive approach reduces the number of semantic incoherencies when suggesting refactorings and during the interaction with the developers. Second, the innovization component improved the quality of the suggested refactoring solutions by using an interactive approach as compared to a regular NSGA-II where the developers need to select one solution from the Pareto front that cannot be updated dynamically. Third, JDeodorant proposes some pre-defined patterns to fix some types of code smells that cannot be sometimes generalized.

To summarize and answer RQ1, the experimentation results confirm that the interactive approach helps the participants to refactor their systems efficiently by finding more relevant refactoring solutions and improve the quality of all the ten systems under study. In addition, the interactive approach provides better results, on average, than all of the existing fully-automated refactoring techniques.

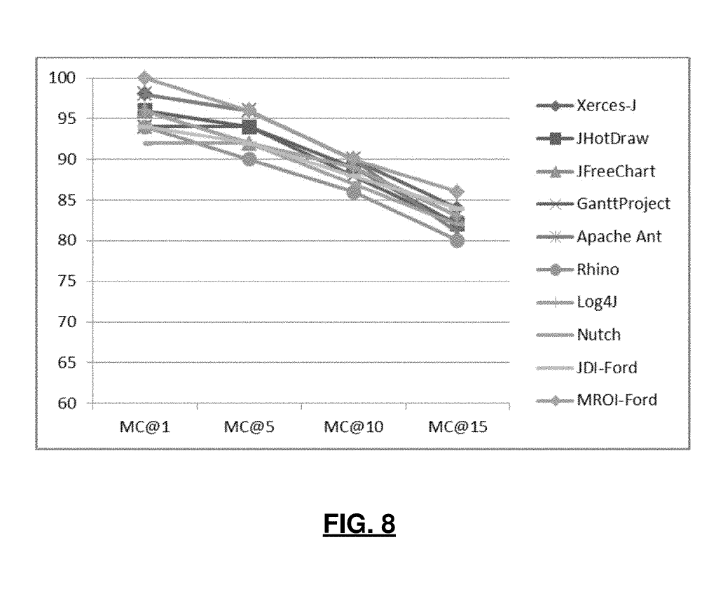

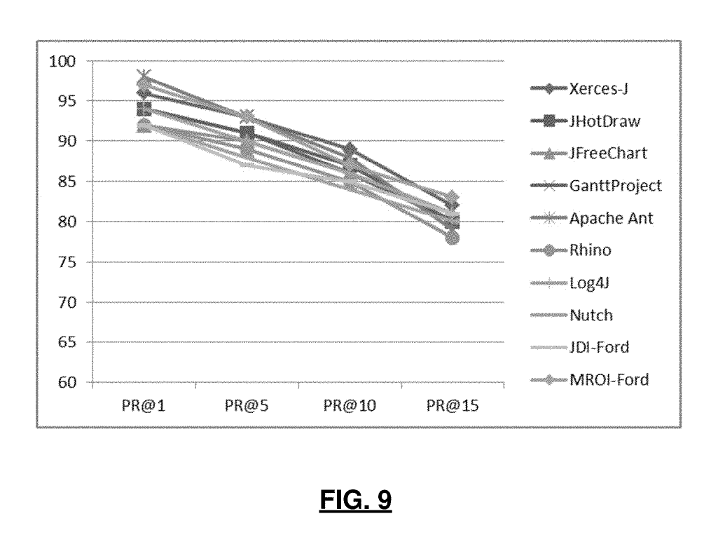

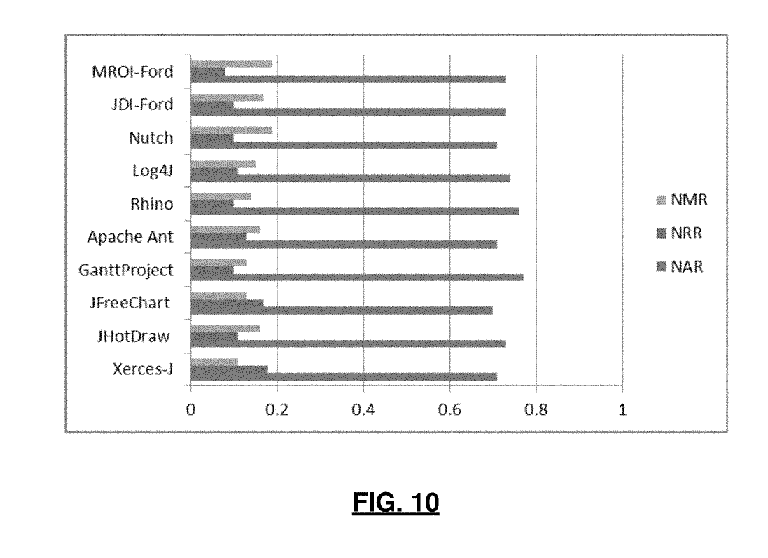

For results for RQ2, the ability of the interactive approach to help software developers to find quickly good refactorings based on an efficient ranking of the proposed operations was also evaluated. The MC@k and PR@k were compared, where k was varied between 1, 5, 10 and 15 as described in FIG. 8 and FIG. 9 where the lowest MC@1 is 93% and the highest is 100% on the different ten systems confirming that the highest-ranked refactoring was almost always correct and relevant for the developers.

The MC@15 presents the lowest results, which is to be expected since it was evaluated the manual correctness of the top 15 recommended refactorings at several interactions and this increases the probability that it contains few irrelevant refactorings. However, the average MC@15 still could be considered acceptable with an average of more than 81%. The same observations are also valid for the PR@k; however the results are a bit lower than for MC@k. The average PR@k results were respectively 94%, 89%, 84% and 80% for k=1, 5,10 and 15. Thus, it is clear that the ranking function used by our interactive approach to explore the Pareto front is efficient.

Considering three other metrics NAR (percentage of ac-cepted refactorings), NMR (percentage of modified refactorings) and NRR (percentage of rejected refactorings), the efficiency of the interactive approach is further evaluated to rank the refactorings. These metrics are recorded using a feature that implemented in our tool to record all the actions performed by the developers during the refactoring sessions. FIG. 10 shows that, on average, more than 71% of the recommended refactorings were applied by the devel-opers. In addition, an average of 17% of the recommended refactorings were modified by the developers, while 12% of the suggested refactorings were rejected by the developers. Thus, it is clear that the recommendation tool successfully suggested a good set of refactorings to apply. To conclude, this approach efficiently ranked the recom-mended refactorings and helped software developers to quickly find good refactorings recommendations.

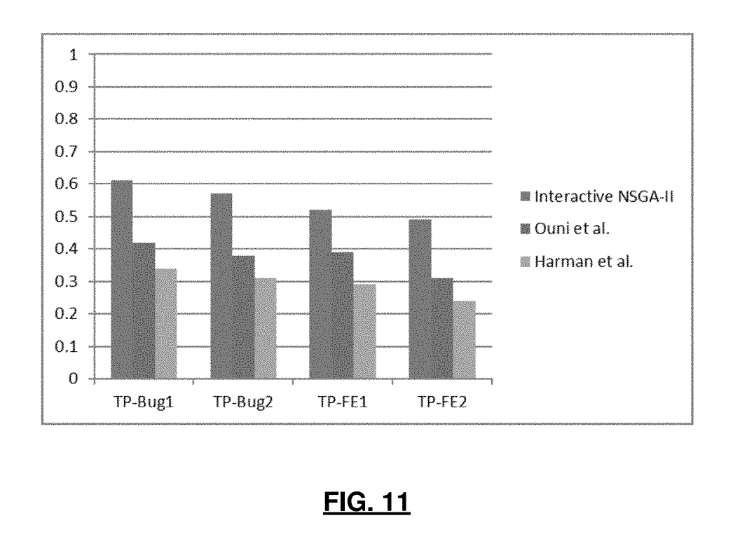

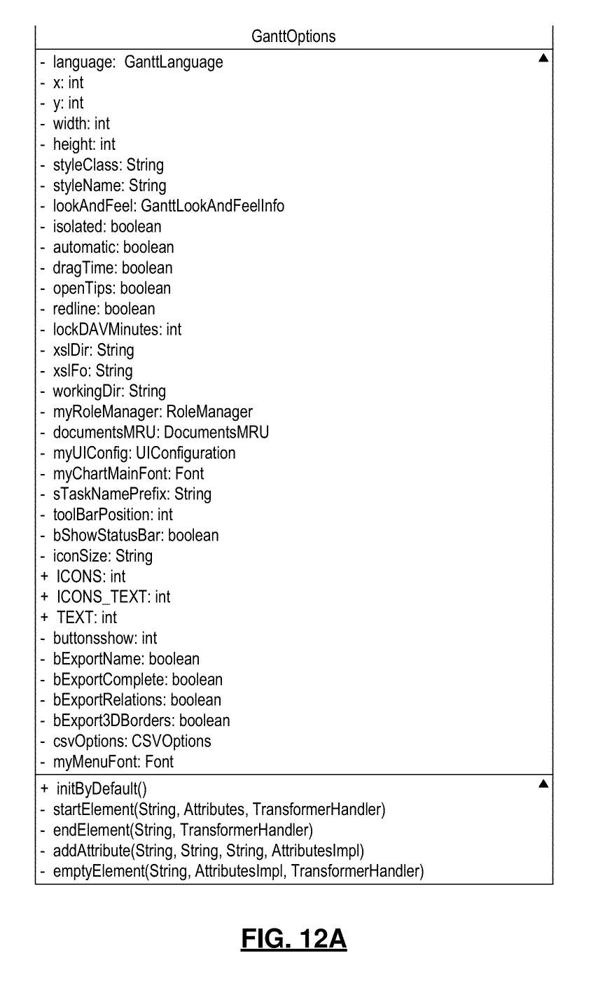

For results for RQ3a, FIG. 11 shows that the time is reduced by 61% and 57% to finalize respectively the two tasks of fixing bugs when programmers worked on the refactored program using our interactive approach. These results outperform the productivity improvements obtained when programmers worked on similar tasks of fixing bugs of the refactored programs by Ouni et al. and Harman et al. For Ouni et al., the productivity improvements are between 41% and 37% while Harman et al. are between 33% and 31%. The results are correlated with the quality improvements of the evaluated programs, as discussed in the previous sections. Thus, a better quality of the software may increase the productivity of programmers when fixing bugs.

For results for RQ3b, similar results to RQ3a are obtained for the tasks of adding new features. FIG. 11 shows that the time is reduced by 51% and 48% to finalize respectively the two tasks of adding new features when programmers worked on the refactored program using the interactive approach. These results outperform the productivity improvements obtained when programmers worked on similar tasks of adding features of the refactored programs by Ouni et al. and Harman et al. For Ouni et al., the productivity improvements are between 38% and 31%, while Harman et al. are between 29% and 23%. The results are correlated with the quality improvements of the evaluated programs. Thus, a better quality of the software may increase the productivity of programmers when adding new features. Overall, the productivity gain when programmers worked on adding new features is lower than the one observed for fixing bugs. This could be related to the fact that the complexity of adding new features was higher than fixing bugs and the locations where refactorings are introduced.

The metric (TP) to measure the time to perform the different bugs fixing and adding new features task on the systems before and after refactoring included the execution time of the different (interactive and fully-automated) refactoring techniques to generate the new systems after refactoring. While the execution time of the interactive approach is slightly higher than fully-automated approaches with an average of 6 minutes comparing to Ouni et al. and Harman et al. on the different systems used in both scenarios, the overall time that developers spent to perform the new tasks is much lower when working on the new systems after refactoring based on our approach comparing to the state of the art. Thus, the extra manual effort required by the interactive approach is compensated by higher productivity and better accuracy of the results. It is believed that the slightly higher execution time by the interactive approach comparing to fully automated search-based refactoring despite the extramanual effort is explained by the fact that the user feedback can reduce dramatically the search space to converge toward better recommendations. Furthermore, the efficient ranking of refactorings to be inspected by programmers help a lot in reducing the interaction time. Finally, it should be highlighted that programmers spend considerable time evaluating long list of refactoring recommendations after the execution of fully-automated approaches which is comparable to the manual interaction effort required during the execution of our interactive approach.

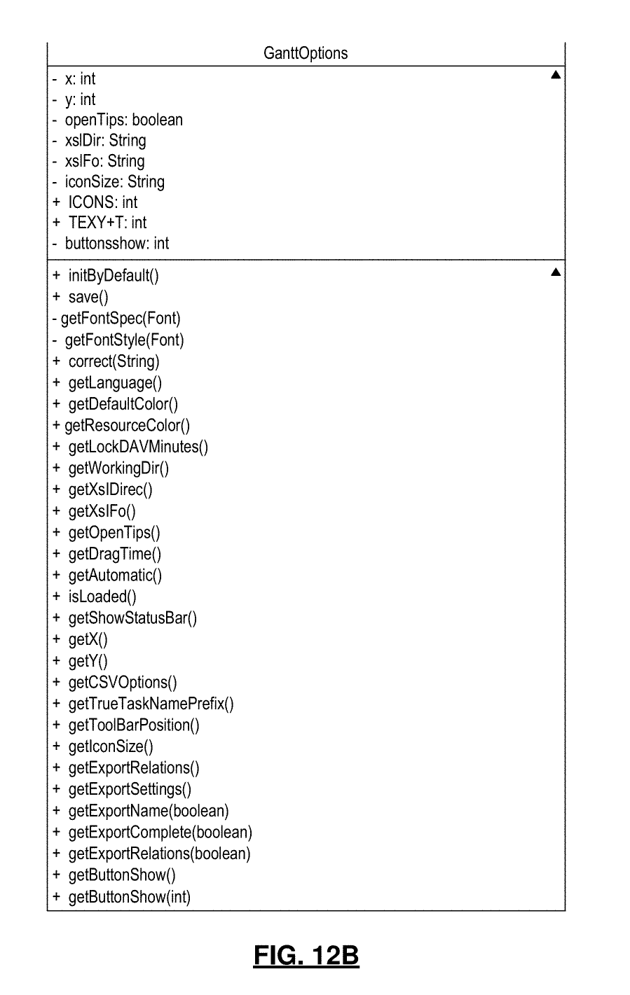

In the following, a qualitative example is described to illustrate the observed time reduction when updating a feature on the refactored code. The scenario consists of modifying the existing loading and saving of CSV files feature in Gant. The updated feature will enable the modification of colors used in the charts to highlight specific project tasks to match different priorities (e.g. red for high priority task, green for low priority task, etc.) then modify the current CSV format to support the use of colors in the Gantt chart. To implement this feature, several methods have to be modified that append to different classes before refactoring. The main class related to this feature is GanttOptions that includes 68 methods and highly coupled with 14 classes which can be considered as a blob. The interactive refactoring tool proposed a sequence of 29 refactorings to be applied to this class and some related classes (CSVOptions and UlConfiguration). The sequence of refactorings included Extract class. Move field. Move method, PushDown field, PushDown method and Extract method that refactored the GanttOptions as illustrated in FIGS. 12A and 12B.

The new version of GanttOptions contained only 43 methods and several methods and fields were moved from/to CSVOptions and UlConfiguration. Thus, the developers introduced less number of changes to update the methods related to changing the colors of the chart tasks and the format of the CSV files since they were cohesively moved to GanttOptions after refactorings rather than being distributed between CSVOptions and UlConfiguration. These refactorings not only reduced the number of changes but also improved the coupling and cohesion within these classes since other methods and fields were moved from CSVOptions which reduced as well the time for developers to identify the relevant methods and fields to modify to integrate the new features.

For results for RQ3c, the post-study questionnaire results show the average agreement of the participants was 4.8 and based on a Likert scale for the first and second statements, respectively. This confirms the usefulness of the interactive approach for the software developers considered in our experiments.

Most of the participants mention that the interactive approach is faster than manual refactoring since they spent a long time with manual refactoring to find the locations where refactorings should be applied. For example, developers spend time when they decide to extract a class to find the methods to move to the newly created class or when they want to move a method then it takes time to find the best target class by manual exploration of the source code. Thus, the developers liked the functionality of our tool that helps them to modify a refactoring and finding quickly the right parameters based on the recommendations.

The interactive algorithm automatically suggests a list of possible target classes ranked based on the history of changes and semantic similarity. Furthermore, refactorings may affect several locations in the source code, which is a time-consuming task to perform manually, but they can perform it instantly using our tool.

The participants found the tool helpful for both /loss refactoring, to maintain a good quality design and also for root canal refactoring to fix some quality issues such as code smells. The developers justify their conclusions by the following interesting observations about the tool: a) the list of recommended refactorings helps them to choose the desired refactoring very quickly, and b) the tool offers them the possibility to modify the source code (to add new functionality) while doing refactoring since the list of recommendations is updated dynamically. So developers can switch between both activities: refactoring and modifying the source code to modify existing functionalities, c) the tool allows developers to access all the functionality of the IDE (e.g., Eclipse), d) the suggested refactorings by our interactive tool can fix code smells (root canal refactoring) or improve some quality metrics (floss canal refactoring) due to the use of the multiobjective approach.

Another important feature that the participants mention is that the interactive approach allows them to take the advantages of using multi-objective optimization for software refactoring without the need to learn anything about optimization and exploring explicitly the Pareto front to select one ideal solution. The implicit exploration of the Pareto front in an interactive fashion represents an important advantage of the tool along with the dynamic update of the recommended list of refactoring using innovization. In fact, the developers found a lot of difficulties using the multi-objective tool of to explore the Pareto front to find a good refactoring solution. In addition, they did not appreciate the long list of refactoring suggested other solutions since they want to take control of modifying and rejecting some refactorings. In addition, the validation of this long list of refactorings is time-consuming. Thus, they appreciate that the tool suggests refactoring one by one and update the list based on the feedback of developers.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for refactoring software, comprising:
receiving, by a computer processor, a set of candidate solutions for refactoring the software, where each solution in the set of candidate solutions includes one or more refactor operations for the software;
identifying, by the computer processor, a particular candidate solution from the set of candidate solutions, where the particular candidate solution includes refactor operations with highest commonality amongst the set of candidate solutions;
presenting, by the computer processor, a particular refactoring operation from the particular candidate solution to a user;
receiving, by the computer processor, feedback regarding the particular refactoring operation from the user;
updating, by the computer processor, source code for the software based on the feedback from the user; and
generating, by the computer processor, another set of candidate solutions using the updated source code.

2. The computer-implemented method 1 further comprises identifying a given candidate solution by calculating a composite ranking score for each candidate solution in the set of candidate solutions, where the composite ranking score is calculated by computing a ranking score for each refactor operation in a given candidate solution based upon frequency of the refactor operation across the set of candidate solution and summing the ranking score for each refactor operation in the given candidate solution to yield the composite ranking score, such that the particular candidate solution is the candidate solution having highest composite ranking score in the set of candidate solutions.

3. The computer-implemented method of claim 2 wherein presenting a particular refactoring operation includes displaying an indicator to apply the particular refactoring operation to the software, an indicator to modify the particular refactoring operation and an indicator to reject the particular refactoring operation.

4. The computer-implemented method of claim 3 further comprises, in response to receiving feedback from the user, recalculating a composite ranking score for each candidate solution in the set of candidate solutions using the feedback from the user.

5. The computer-implemented method of claim 4 further comprises
a) identifying another candidate solution from the set of candidate solutions, where the another candidate solution has highest composite ranking score after the step of recalculating a composite ranking score for each candidate solution in the set of candidate solutions;
b) presenting a particular refactoring operation from the another candidate solution to a user;
c) receiving feedback regarding the particular refactoring operation from the user; and
d) recalculating a composite ranking score for each for each candidate solution in the set of candidate solutions using the feedback from the user.

6. The computer-implemented method of claim 5 further comprises repeating steps a)-d) until an exit condition is satisfied.

7. The computer-implemented method of claim 4 further comprises recalculating a composite ranking score for a given candidate solution by adding one to the composite ranking score when the given candidate solution includes the particular refactoring operation and the feedback indicates to apply the particular refactoring operation to the software, by adding one half to the composite ranking score when the given candidate solution includes the particular refactoring operation and the feedback indicates to modify the particular refactoring operation, and subtract one to the composite ranking score when the given candidate solution includes the particular refactoring operation and the feedback indicates to reject the particular refactoring operation.

8. The computer-implemented method of claim 1 further comprises generating another set of candidate solutions by applying a genetic algorithm to a set of candidate solutions and thereby yielding a next generation of candidate solutions.

9. The computer-implemented method of claim 8 wherein applying a genetic algorithm includes evaluating each candidate solution in the next generation of candidate solutions according to two fitness functions, where one of the two fitness functions minimizes number of changes to the source code and other of the two fitness functions maximizes software quality.

10. The computer-implemented method of claim 8 further comprises removing one or more candidate solutions from the next generation of candidate solutions based on feedback from the user.

11. A computer-implemented method for refactoring software, comprising:
receiving, by a computer processor, a set of candidate solutions for refactoring the software, where each solution in the set of candidate solutions includes one or more refactor operations for the software;
selecting, by the computer processor, a particular candidate solution from the set of candidate solutions;
presenting, by the computer processor, a particular refactoring operation from the particular candidate solution to a user;
receiving, by the computer processor, feedback regarding the particular refactoring operation from the user;
updating, by the computer processor, source code for the software based on the feedback from the user; and
applying, by the computer processor, a genetic algorithm to the set of candidate solutions and using the updated source code, thereby yielding a next generation of candidate solutions.

12. The computer-implemented method of claim 11 wherein presenting a particular refactoring operation includes displaying an indicator to apply the particular refactoring operation to the software, an indicator to modify the particular refactoring operation and an indicator to reject the particular refactoring operation.

13. The compute-implemented method of claim 12 further comprises receiving an indication to apply the particular refactoring operation from the user and updating the source code for the software in accordance with the particular refactoring operation.

14. The compute-implemented method of claim 12 further comprises receiving an indication to modify the particular refactoring operation from the user and updating the source code for the software in accordance with the particular refactoring operation.

15. The compute-implemented method of claim 12 further comprises receiving an indication to reject the particular refactoring operation from the user and removing select candidate solutions from the next generation of candidate solutions, where the select candidate solutions include the particular refactoring operation.

16. The computer-implemented method 11 further comprises identifying a given candidate solution by calculating a composite ranking score for each candidate solution in the set of candidate solutions, where the composite ranking score is calculated by computing a ranking score for each refactor operation in a given candidate solution based upon frequency of the refactor operation across the set of candidate solution and summing the ranking score for each refactor operation in the given candidate solution to yield the composite ranking score, such that the particular candidate solution is the candidate solution having highest composite ranking score in the set of candidate solutions.

17. The computer-implemented method of claim 16 wherein presenting a particular refactoring operation includes displaying an indicator to apply the particular refactoring operation to the software, an indicator to modify the particular refactoring operation and an indicator to reject the particular refactoring operation.

18. The computer-implemented method of claim 17 further comprises, in response to receiving feedback from the user, recalculating a composite ranking score for each candidate solution in the set of candidate solutions using the feedback from the user.

19. The computer-implemented method of claim 18 further comprises
a) identifying another candidate solution from the set of candidate solutions, where the another candidate solution has highest composite ranking score after the step of recalculating a composite ranking score for each candidate solution in the set of candidate solutions;
b) presenting a particular refactoring operation from the another candidate solution to a user;
c) receiving feedback regarding the particular refactoring operation from the user; and
d) recalculating a composite ranking score for each for each candidate solution in the set of candidate solutions using the feedback from the user.

20. A computer-implemented method for refactoring software, comprising:
receiving, by a computer processor, a set of candidate solutions for refactoring the software, where each solution in the set of candidate solutions includes one or more refactor operations for the software;
selecting, by the computer processor, a particular candidate solution from the set of candidate solutions;
presenting, by the computer processor, a particular refactoring operation from the particular candidate solution to a user;
receiving, by the computer processor, feedback regarding the particular refactoring operation from the user;
applying, by the computer processor, a genetic algorithm to the set of candidate solutions, thereby yielding a next generation of candidate solutions; and
removing, by the computer processor, select candidate solutions from the next generation of candidate solutions based on feedback from the user, where the select candidate solutions include the particular refactoring operation.
